(19) United States
(12) Patent Application Publication
(10) Pub. No.: US 2023/0316870 A1
(43) Pub. Date: Oct. 5, 2023

(54) LOCATION BASED GAMES, LOTTERIES, AND SWEEPSTAKES AND TICKETS, SYSTEMS, TECHNOLOGIES, AND METHODS RELATED THERETO

(71) Applicant: Multilot AS, Miami, FL (US)

(72) Inventor: Reidar Magnus Nordby, Oslo (NO)

(21) Appl. No.: 18/130,856

(22) Filed: Apr. 4, 2023

Related U.S. Application Data
(63) Continuation-in-part of application No. 17/316,542, filed on May 10, 2021.
Application No. 17/316,542 is a continuation-in-part of application No. 16/847,358, filed on Apr. 13, 2020, now Pat. No. 11,011,027.
Application No. 16/847,358 is a continuation-in-part of application No. 16/572,546, filed on Sep. 16, 2019, now Pat. No. 11,244,538.
Application No. 16/572,546 is a continuation-in-part of application No. 15/968,702, filed on May 1, 2018, now Pat. No. 10,565,823.
(60) Provisional application No. 63/327,233, filed on Apr. 4, 2022.
(60) Provisional application No. 62/859,722, filed on Jun. 11, 2019.
(60) Provisional application No. 62/846,532, filed on May 10, 2019.
(60) Provisional application No. 62/846,536, filed on May 10, 2019.
(60) Provisional application No. 62/846,506, filed on May 10, 2019.
(60) Provisional application No. 62/731,636, filed on Sep. 14, 2018.

(51) Int. Cl. G07F 17/32

(52) U.S. Cl. CPC G07F 17/329; G07F 17/3223; G07F 17/3241

(57) ABSTRACT

Games, lotteries, and/or sweepstakes as well as tickets, systems, technologies, and/or methods related thereto. In some embodiments, a gaming hub or clearing house which is used to screen prospective game contestants prior to permitting their participation with games, sweepstakes, and/or lotteries and/or as well as for monitoring contestant play. In certain alternative embodiments, the game network access granting hub utilizes facial recognition technology to screen prospective game contestants. Location based games and/or games which take place in synthesized worlds or hybrid worlds comprised of merged real and virtual scenes.

### CROSS-REFERENCE TO RELATED APPLICATIONS

This application claims priority to U.S. Provisional Application No. 63/327,233, filed Apr. 4, 2022. This application is a continuation-in-part of U.S. application Ser. No. 17/316,542, filed May 10, 2021, which is a continuation-in-part of U.S. application Ser. No. 16/847,358, filed on Apr. 13, 2020, which is a continuation in part of U.S. application Ser. No. 16/572,546, filed on 2019 Sep. 16, which claims the benefit of U.S. Provisional Application No. 62/859,722, filed on 2019 Jun. 11, U.S. Provisional Application No. 62/846,532, filed on 2019 May 10, U.S. Provisional Application No. 62/846,536, filed on 2019 May 10, U.S. Provisional Application No. 62/846,506, filed on 2019 May 10, and U.S. Provisional Application No. 62/731,636, filed on 2018 Sep. 14; and is a continuation in part of U.S. application Ser. No. 15/968,702, filed on 2018 May 1.

### FIELD OF INVENTION

This invention relates to games, lotteries, and/or sweepstakes as well as to tickets, systems, technologies, and/or methods related thereto. In some embodiments, this invention relates to a gaming hub or clearing house which is used to screen prospective game contestants prior to permitting their participation with games, sweepstakes, and/or lotteries and/or as well as for monitoring contestant play. In other embodiments, this invention relates to methods and mechanisms for permitting cash payment for online game, lottery, and/or sweepstakes plays. In still additional embodiments, the disclosed inventions related to location based games and/or games which take place in synthesized worlds or hybrid worlds comprised of merged real and virtual scenes.

### BACKGROUND OF THE INVENTION

Lotteries have existed in various forms throughout the world for hundreds of years. Typical modem lottery formats often involve the selection by a customer or entrant of a pre-determined quantity of lottery numbers (e.g., from a range of numbers) such as by writing such numbers down on a paper form which is submitted to a store clerk. Once the lottery ticket is paid for, such numbers are then entered into a machine which prints, on a second piece of paper, a lottery ticket which is issued to the lottery customer. Lottery winners in such conventional lotteries are eventually chosen by a lottery administrator which—via one or more conventional methods—draws or randomly selects winning numbers which an entrant must have selected, and thereby have a paper ticket with numbers matching the winning numbers, to win the lottery prize. If the lottery ticket is lost, the contestant—even if he or she were a winner—would be unable to collect his/her prize. In such lottery types, because the contestant is able to choose whatever numbers he or she desires, multiple winners may result in a given lottery draw (i.e., which necessitates prize sharing). Conversely, because there is no guarantee that the numbers drawn will precisely match any set of numbers chosen by a lottery contestant, a given lottery draw may result in no winner at all.

In a popular second type of lottery format, paper tickets are sold to lottery customers which are a scratch-off type or variety. With such a lottery ticket, often the ticket is predetermined as either a winner or a loser and the customer discovers the “result” of the ticket by scratching or rubbing off an opaque film which conceals whether the ticket is a winning or losing ticket. Because of the simplicity of their design and implementation, there are often a large variety of scratch-off lottery ticket types which compete with one another.

As most conventional lottery types employ paper tickets, not only does the printing of massive numbers of throw away tickets have an environmental impact, but it also requires substantial financial expenditure by the lottery provider to design, print, store, and ship the tickets to large numbers of geographic locations.

Moreover, despite certain benefits of lotteries such as when portions of profits are used to fund local governments or charities, there are certain social stigmas associated with lotteries because of their possible impact among those susceptible to gambling addiction, for example. Further, often those people in the least wealthy social classes are the persons purchasing the most lottery tickets.

Finally, there has been a decline in the popularity of lotteries in recent years (at least in certain markets and countries) possibly due to lack of excitement or enthusiasm associated with conventional lottery types. In this regard, the public has arguably become sensitized to the conventional lottery formats and therefore does not participate in lotteries in historically high numbers.

Recognizing the above-described drawbacks of conventional lottery types, certain needs in the lottery arts have been identified by the inventors of the application for patent contained herein. Similar needs have been identified related to games and sweepstakes, as well as in relation to systems, technologies, and/or methods pertaining to lotteries, games, and sweepstakes. For the purposes of this application, such terms (“lotteries”, “games”, and “sweepstakes”) may be and are used interchangeably, and the use of one term is not intended to exclude the others from its scope, absent an explicit identification of an intent to do so (if any). Therefore, a new technology or described with respect to a “lottery”, for example, is equally applicable to a “game” or “sweepstake”, unless otherwise specifically stated.

Addressing one of many newly discovered needs, applicant has discovered that there is a desire by game or lottery players to experience travel to geographic areas remote from their home geographic location, so that they can participate in game or lottery or gambling play, even if it is not legal to participate in gambling type activities in the desired target location. Another need which has been discovered is the desire for game or lottery players to have more game or lottery or gambling options in their home geographic location, particularly if game or lottery options are limited at their home location. Still another need which has been discovered is the desire of game or lottery players to be incentivized to participate in local travel and/or outdoor activities, such as for exercise and health, such as by integrating game play and/or lottery play into exercise, outdoor, and/or travel activities. Another need discovered by applicant is the need to enhance the entertainment of game and lottery play such that the gaming or lottery experience is more prolonged and rich, as compared to a conventional lottery.

In view of the above-enumerated drawbacks and/or needs or desires for improvements in the arts, it is a purpose of the herein described invention to address one or more of such drawbacks and/or desires as well as, or in the alternative, other needs which will become more apparent to the skilled artisan once given the present disclosure.

### SUMMARY OF CERTAIN EMBODIMENTS OF THE INVENTION

Generally speaking, certain embodiments of this invention relate to unique apparatus, systems, and methods which embody, generate, synthesize, and/or deliver (and/or for embodying, generating, synthesizing, and/or delivering) real and/or virtual world experiences. In some embodiments, hybridized real/virtual world experiences are enabled, generated, and/or provided. For example, a real world view visible on a user-viewable display may be supplemented with virtual imagery and/or virtual experiences in some embodiments. In other embodiments, virtual worlds can be supplemented with real world imagery and/or real experiences. In still other embodiments, real and virtual world imagery and/or experiences are enabled, generated, and/or provided generally collectively generally co-equally (or in other ratios), such that an experience displayed on a user display or monitor is a mostly equal (or other) mix of real and virtual world imagery and actions. Of course, any proportional synthesis of real-virtual worlds is possible, such as described further below.

In certain non-limiting embodiments, the inventions described herein relate to apparatus and/or systems which can be used by a human user to virtually travel through real world derived scenes on a user-viewable display. For example, as discussed in more detail in the Detailed Description section, a user of the herein described apparatus and/or systems may view a display which depicts a user's travel through a virtual world which corresponds, at least in some respects, to a real world, and the real world location and travels of the user in particular. That is, as a user travels through the real world, a real-world geographic location of the user is detected, and any travel of the user is autonomously and automatically monitored. Based on such detected geographic location and travels, a hybridized real and virtual world view is synthesized and then displayed to the user, preferably to provide an interactive experience. Moreover, as the user travels, the hybridized real/virtual world view reflects such travel by continuing to synthesize hybridized real/virtual world imagery, in real time, while displaying the hybridized imagery to the user (e.g., again, preferably accompanied by opportunities for user interactivity). Display is possible in two-dimensional variants or in three-dimensional or virtual reality type variants as desired.

In one specific example of the multiple inventions described herein, games, such as lotteries or sweepstakes or gambling type games (or other games of skill or chance) can be provided. For example, in embodiments in which users virtually travel through hybridized real/virtual world imagery, games may be provided or offered at selected geographic locations in the synthesized real/virtual world. In a more specific (but non-limiting) example, games may be provided at specific locations or landmarks in a virtual-world (e.g. corresponding to or similar to real world locations) with the goal of driving real-world user traffic to the real-world locations or landmarks. By way of a further non-limiting example, the apparatus and systems described herein can be used to motivate the travel or exercise of a human user by requiring the human user to travel to a real-world geographic location corresponding to the synthesized real/virtual world location of a game or other desirable activity. Numerous embodiments of such apparatus and systems, including variants thereof, are summarized herein below and described in more specific detail in the Detailed Description section below. When interpreting the herein described disclosure and numerous described inventions, the terms “games”, “lottery”, or “sweepstakes” (whether used in the singular or plural) are used interchangeably unless otherwise indicated (and inter alia include games of skill and games of chance).

According to one example embodiment, there is provided: an apparatus comprising a mobile computing device including at least one data processor, and at least one data storage device; the mobile apparatus receiving real-world mapping data, including data corresponding to real-world locations, accessed and processed by the one or more data processors; the mobile apparatus receiving virtual-world mapping data, including data corresponding to virtual-world locations, accessed and processed by the one or more data processors; the one or more data processors overlaying at least a portion of the virtual world mapping data onto at least a portion of the real-world mapping data to synthesize a hybridized real/virtual-world data stream; the one or more data processors processing the real/virtual-world data stream to generate visual-display-data, the visual-display-data being processed by the one or more data processors to generate a visual display on a user viewable display apparatus, the visual display comprising a user-viewable-view of a real-world scene which is periodically or continuously overlayed with a virtual world scene; the mobile computing device containing a location detecting mechanism which at least periodically detects a real world location of the mobile computing device, and when the mobile computing device is detected, by the location detecting mechanism, to be located at a specified game-location-target, a game is made accessible to a user of the mobile computing device while the mobile computing device remains at the game-location-target; and and wherein laws applicable to the detected real world location of the mobile computing device are determined according to the detected real world location and thereafter applied by the game network access granting hub to determine and select which games are accessible by the mobile computing device at specific detected locations.

In yet another example embodiment, there is provided: an apparatus comprising a mobile computing device including at least one data processor, and at least one data storage device; the mobile computing device receiving real-world mapping data, including data corresponding to real-world locations, accessed and processed by the one or more data processors; the mobile computing device receiving virtual-world mapping data, including data corresponding to virtual-world locations, accessed and processed by the one or more data processors; the one or more data processors overlaying at least a portion of the virtual world mapping data onto at least a portion of the real-world mapping data to synthesize a hybridized real/virtual-world data stream; the one or more data processors processing the real/virtual-world data stream to generate visual-display-data, the visual-display-data being processed by the one or more data processors to generate a visual display on a user viewable display apparatus, the visual display comprising a user-viewable-view of a real-world scene which is periodically or continuously overlayed with a virtual world scene; the mobile computing device containing a location detecting mechanism which at least periodically detects a real world location of the mobile computing device, and when the mobile computing device is detected, by the location detecting mechanism, to be located at a specified game-location-target, a game is made accessible to a user of the mobile computing device while the mobile computing device remains at the game-location-target; and wherein the real-world scene is generated live utilizing a camera onboard the mobile computing device, and wherein the virtual world is generated from virtual world data supplied to the mobile computing device; and wherein the game is rendered from virtual world data, and the game is visible in the user-viewable-view of a real-world scene.

In still an additional embodiment, there is provided: an apparatus comprising a mobile computing device including at least one data processor, and at least one data storage device; the apparatus receiving real-world mapping data, including data corresponding to real-world locations, accessed and processed by the one or more data processors; the apparatus receiving virtual-world mapping data, including data corresponding to virtual-world locations, accessed and processed by the one or more data processors; the one or more data processors overlaying at least a portion of the virtual-world mapping data onto at least a portion of the real-world mapping data to synthesize a hybridized real/virtual-world data stream; the one or more data processors processing the real/virtual-world data stream to generate visual-display-data, the visual-display-data being processed by the one or more data processors to generate a visual display on a user viewable display, the visual display comprising a user-viewable-view of a real-world scene which is periodically or continuously overlayed with a virtual world scene; the mobile computing device containing a travel detecting mechanism which detects when the mobile computing device is physically travelling and which determines a distance of physical travel of the mobile computing device, and wherein when the mobile computing device is determined to have travelled in excess of a selected-target-travel-distance, a game is made accessible to a user of the mobile computing device; the mobile computing device further containing a location detecting mechanism which at least periodically detects a real world location of the mobile computing device; wherein laws applicable to the detected real world location of the mobile computing device are determined according to the detected real world location and thereafter applied to determine and select which games are accessible by the mobile computing device at a specific detected location.

In another non-limiting embodiment, there is provided: a game network comprising data transmission equipment, at least one game network data processor, and at least one game network data storage device; the game network including hardware and/or software particularly configured to control the game network such that it operates to provide a game network access granting hub on which the following method steps are performed: an applicant-game-contestant electronically submitting applicant access credentials comprising identifying information to the game network access granting hub, accompanied by a request for access to a network of a plurality of games which are selectively accessible to applicant-game-contestants which have been approved for access to the game network access granting hub; the game network access granting hub receiving the applicant access credentials, processing the applicant access credentials, performing steps to verify a true identity of the applicant-game-contestant, and screening the applicant-game-contestant for criteria to permit or deny entry into the network of a plurality of games for participating in game play; wherein when the applicant-game-contestant is approved for access to the network of a plurality of games, the applicant-game-contestant is granted access to a plurality of electronic games; a mobile apparatus communicably connected to the game network, the mobile apparatus comprising a mobile computing device including one or more mobile device data processors, and one or more mobile apparatus data storage devices; the mobile apparatus receiving real-world mapping data, including data corresponding to real-world locations, accessed and processed by the one or more data processors; the mobile apparatus receiving virtual-world mapping data, including data corresponding to virtual-world locations, accessed and processed by the one or more data processors; the one or more data processors combining, at least periodically, at least a portion of the virtual world mapping data and at least a portion of the real-world mapping data to synthesize a hybridized real/virtual-world data stream; the one or more data processors processing the real/virtual-world data stream to generate visual-display-data, the visual-display-data being processed by the one or more data processors to generate a visual display on a user viewable display, the visual display comprising a user-viewable-view of a real-world scene which is periodically or continuously overlayed with a virtual world scene; the mobile computing device containing a location detecting mechanism which at least periodically detects a real world location of the mobile computing device, and wherein laws applicable to the detected real world location of the mobile computing device are determined according to the detected real world location and thereafter applied by the game network access granting hub to control which games are accessible by the mobile computing device at specific detected locations and/or to tailor rules of game play; and wherein if the mobile computing device is detected, by the location detecting mechanism, to be located at a specified game-location-target, a game is made accessible while the mobile computing device remains at the game-location-target.

In one or more variants of the above-described inventions, a plurality of electronic games are provided with the apparatus and/or systems by a plurality of third party providers located in a plurality of states of the United States.

In one or more variants of the above-described inventions, at least one of the plurality of games offered is made accessible while said mobile computing device remains at said game-location-target, only if said game is determined to be legal in the geographic location detected by said location detecting mechanism, after said game network autonomously and automatically determines whether said game, lottery, or sweepstakes is compliant with laws of the detected geographic location by parsing a database pertaining to such laws.

In one or more variants of the above-described inventions, laws applicable to said detected real world location of said mobile computing device are determined according to said detected real world location and thereafter applied by said game network access granting hub to determine and select which games are accessible by said mobile computing device at specific detected locations.

In one or more variants of the above-described inventions, the apparatus is communicably connected to a game network comprising data transmission equipment, at least one game network data processor, and at least one game network data storage device; said game network including hardware and/or software particularly configured to control said game network such that it operates to provide a game network access granting hub on which the following method steps are performed: an applicant-game-contestant electronically submitting applicant access credentials comprising identifying information to said game network access granting hub, accompanied by a request for access to a network of a plurality of games which are selectively accessible to applicant-game-contestants which have been approved for access to said game network access granting hub; said game network access granting hub receiving said applicant access credentials, processing said applicant access credentials, performing steps to verify a true identity of said applicant-game-contestant, and screening said applicant-game-contestant for criteria to permit or deny entry into said network of a plurality of games for participating in game play; wherein when said applicant-game-contestant is approved for access to said network of a plurality of games, said applicant-game-contestant is offered game play when said mobile computing device is detected to be located a specified game-location-target.

In one or more variants of the above-described inventions, the plurality of games are preferably electronically provided by a plurality of third party providers located in a plurality of states of the United States.

In one or more variants of the above-described inventions, the travel detecting mechanism of said mobile computing device is so designed as to be capable of determining whether physical travel is by human locomotion versus machine assisted locomotion.

In one or more variants of the above-described inventions, only physical travel which occurs by human locomotion, to the exclusion of machine assisted locomotion, is tallied when determining whether a distance of physical travel of said mobile computing device is in excess of said selected-target-travel-distance.

In one or more variants of the above-described inventions, mobile computing device travel distances are tallied by said mobile computing device as detected by said travel detecting mechanism, and when travel is detected to occur by human locomotion only, a game is made accessible to a user of said mobile computing device when said mobile computing device has travelled in excess of a selected-target-travel-distance; and when travel is detected to occur by machine assisted locomotion, a game is made accessible to a user of said mobile computing device when said mobile computing device has travelled in excess of a target-machine-locomotion-travel-distance, which is a distance greater than said selected-target-travel-distance.

In one or more variants of the above-described inventions, a device for motivating physical human-powered movement of a human user is provided, integrating the apparatus and/or systems described herein. In such example embodiments, if no human locomotion is detected, no game is made accessible to a user of said mobile computing device. In the same or other but similar embodiments, if only machine assisted locomotion is detected, a message is displayed in said user-viewable-view notifying a user of said mobile computing device that games will not be made accessible to said user during said machine assisted locomotion. In still other similar embodiments, if only machine assisted locomotion is detected, use of said mobile computing device is suspended. In still further similar embodiments, if machine assisted locomotion is detected, game play is (as an optional feature) suspended.

In one or more variants of the above-described inventions, a database is included which contains a plurality of game-location-targets which is accessed by said mobile computing device, said game-location targets being selected by a plurality of third party entities. In some of these embodiments, a plurality of third party entities self-upload said plurality of game-location-targets into said database containing said plurality of game-location-targets.

In one or more variants of the above-described inventions, a plurality of third party entities self-upload said plurality of game-location-targets into said database containing said plurality of game-location-targets, and said plurality of third party entities supply target-affiliated electronic game data, for generating a game in said user-viewable-view, when said mobile computing device is detected to be at a geographic location corresponding to one of said plurality of game-location-targets supplied by one of said plurality of third party entities. In these or different embodiments, target-affiliated electronic game data is tailored to specific game-location-targets, such that different game-location-targets are affiliated with different target-affiliated electronic game data, Moreover, the different target-affiliated electronic game data, when processed by said mobile computing device, generates different games playable on said mobile computing device.

In one or more variants of the above-described inventions, the plurality of third party entities supply target-affiliated electronic game data, for generating a game in said user-viewable-view, when said mobile computing device is detected to be at a geographic location corresponding to one of said plurality of game-location-targets supplied by one of said plurality of third party entities. Further the target-affiliated electronic game data is preferably tailored to specific game-location-targets, such that different game-location-targets are affiliated with different target-affiliated electronic game data. Also in these or similar embodiments, the different target-affiliated electronic game data, when processed by said mobile computing device, generates different games playable on said mobile computing device.

In one or more variants of the above-described inventions, a plurality of third party entities collectively supply a plurality of said target-affiliated electronic game data corresponding to a plurality of different games playable on said mobile computing device, and the plurality of third party entities are located in a plurality of states of the United States.

Although third party entities are discussed in detail above and elsewhere in the specification, it is also possible—of course—for the game network supplier to supplant third parties entirely, or for it to participate alongside or in conjunction with third parties (e.g., in supplying games or game-location-targets, etc.).

In one or more variants of the above-described inventions, a game of said plurality of different games is made accessible while said mobile computing device remains at a said game-location-target, only if said game is determined to be legal in the geographic location detected by said location detecting mechanism, after said game network autonomously and automatically determines whether said game, lottery, or sweepstakes is compliant with laws of the detected geographic location by parsing a database pertaining to such laws.

In one or more variants of the above-described inventions utilizing user access credentials, the applicant access credentials comprise the face of said applicant-game-contestant, which is detectable using facial recognition technology and is compared to a facial image of said applicant-game-contestant stored in a screening database associated with said game network access granting hub. In these or similar embodiments, the facial recognition technology preferably utilizes a camera in, or otherwise connected to or associated with said mobile computing device of said applicant-game-contestant. In such or different embodiments, the camera preferably monitors a face of a user of said mobile computing device by periodically or continuously comparing said user's face to a facial image of said applicant-game-contestant stored in said screening database. Still further, the optional facial recognition capabilities may be used to prevent children, other family members, or another unauthorized user from accessing a player profile of said applicant-game-contestant. As an additional optional feature, if an unauthorized use of a player profile is detected using face identification features, the facial recognition (optionally) technology takes a photograph or video of said unauthorized user, followed by transmitting said photograph or video to said applicant-game-contestant to identify said unauthorized user.

In one or more variants of the above-described inventions, applicant access credentials may also optionally include an internet protocol (IP) address, MAC address, or other identifier of said laptop, other computer, or mobile device of said applicant-game-contestant, so that if an IP address, MAC address, or other identifier of a user does not match said applicant-game-contestant's IP address, MAC address, or other identifier stored in said screening database associated with said game network access granting hub, said game network access granting hub can utilize said facial recognition technology to compare said user's face to said facial image of said applicant-game-contestant stored in said screening database associated with said game network access granting hub. Data such as IP addresses (or GPS data) may also be used to detect location, such location being usable to determine which games are available based on the automated querying of laws in an accessible database.

In one or more variants of the above-described inventions, the apparatus and/or systems optionally include and utilize software generated virtual characters which appear in said user-viewable-view during a said game. In these or similar embodiments, an image of said face of said applicant-game-contestant, which is captured utilizing said camera utilized with said facial recognition technology, is integrated into said game as a visual representation of a game character.

In one or more variants of the above-described inventions, a user-viewable-view is (optionally) supplemented with imagery stored in a database which is representative of said real world location detected by said location detecting mechanism.

In one embodiment, there is provided a game administration method comprising the steps of: a game contestant electronically submitting identifying information and payment information to an electronic game provider hub; the game provider hub verifying the identify of the game contestant and screening the game contestant for criteria to permit or deny entry into a gaming system for participating in game play; wherein when the game contestant is approved for game play, the game contestant is granted access to a plurality of games, lotteries, and/or sweepstakes administered by an electronic game provider. In similar embodiments, data created and thereafter stored when the game administration method is used, is utilized for monitoring and/or restricting game play of contestants.

In one embodiment, facial recognition technology is used in connection with the game provider hub, or similar technologies, to provide additional security-like features. For example, game players (or contestants) utilizing a Game Provider hub (or similar game hub) may have underage children in the household who have access to the game player's computer and discover the game player's credentials for accessing the hub.

In this embodiment, for example, a camera in, or otherwise connected to or associated with, a laptop, other computer, or mobile device, for example, monitors the face of a user of the laptop, other computer, or mobile device by periodically or continuously comparing the user's face to a facial image or images of the game player stored in a screening database (associated with the game player's verified identity) maintained by the Game Provider, for example, to prevent children or other family members, or other unauthorized users, from accessing the contestant's player profile. The facial recognition feature also can be utilized if the laptop, other computer, or mobile device is stolen, in which case facial detection and verification will prevent unauthorized use of the player profile.

In another embodiment, variants of which are discussed herein below, a game administration method is provided wherein a prospective game contestant pays for game play by purchasing a physical game play ticket containing a code, and wherein the code is provided to the electronic game provider hub to prove payment for game play.

In some of the above or other embodiments, there is provided a system and/or method to be used or integrated with lotteries, such as described in the example embodiment(s) below:

Lottery Clearing House and/or Entry Hub

The following is a description of a system or method for (in some embodiments) preventing the following, negative consequences of gambling, such as: gambling addiction; lack of age control; the player losing his/her ticket; theft of tickets; pollution (paper tickets). In one or more of such embodiments, the player must, before participating in a game of chance, supply two or more of the following: full name; address; phone number; debit card number; credit card number; email address; social security number; date of birth; and/or bank account number. The information is optionally, but preferably, provided by the participant via a mobile phone application or via a website. After the information is sent to the database, it is cross referenced with other sources of information (e.g., driver license information, IP address, encryption token) to ensure that the identity of the participant is correct and that the participant is of legal gambling age. Each participant can preferably only have one player profile. The participant can then, via the participant's credit or debit card, participate in games of chance.

In more specific, alternative embodiments, a gaming entry and/or security hub is provided, the use of which can provide access to a variety of lotteries, sweepstakes, or other games, in diverse locations. For example, in a lottery (or gaming, sweepstakes, or gambling program) deployed for play throughout the United States, a central gaming hub can be maintained which serves as a central entry point and/or clearing house for game entrants, for a plurality of games, located at multiple locations around the United States (or other locations or regions throughout the world, such as within the various member countries of the European Union). Although the term “hub” is used, the meaning of such term is to convey that one or more game contestant registration and/or entry points are provided but where all (or substantially all) registrations or entries pass through a centralized database and/or screening procedure.

By way of more specific example, if a game provider (or developer) within the United States (hereinafter “Game Provider”) wishes to launch a plurality of games accessible to citizens or residents of (or a portion of) the states of the United States of America, the Game Provider will provide or construct a clearing house which includes servers, including computer processors and one or more databases, for intaking contestant information and entries and, through software operations, for processing said contestant information and entries. Of course, the clearing house may also be constructed by third party contractors according to the necessary operational parameters provided by the Game Provider and/or governmental entity. More particularly, as but one example configuration, a Game Provider can provide one or more web portals (e.g., accessible through a uniform resource locator (“URL”) via a web browser connected to the internet) by which a prospective contestant (or game player) can access the hub. If multiple URLs are used to access the webportal, the URLs can be customized to provide information about a specific game in which the prospective contestant has acquired interest. For example, if a “bingo” game and photo-lottery game (as described herein) are both being simultaneously promoted by the Game Provider, an example URL could optionally be selected to be www.gameprovidername_bingo.com for the bingo-style game, and www.gameprovidername_photolotto.com for the photo-lottery style game. Of course, these are examples only, and any unique URL which is available (e.g., not prior reserved or owned by a different entity) can be selected to utilized for access to the hub. The URLs, in turn, will preferably each access the same clearing house (or “hub”) or at least a similar clearing house, which performs the same or similar operations of duplicate (or substantially duplicate), “mirror” hubs. In other words, if multiple clearing house or hub locations (or multiple units of hub-enabling equipment) are utilized, the multiple clearing houses will preferably perform the same entry, registration, and/or screening operations because they each access mirrored (e.g., duplicated) or at least substantially similar databases and contain software with the same or similar operating commands. Accordingly, if different URLs are utilized for different games (such as described in this paragraph), such different URLs can “point” to a specific clearing house provisioned for a specific game (or lottery or sweepstakes) or they can be configured to “point” to the same clearing house which is provisioned to screen and process prospective contestants for both game types. Of course, many additional game types, and therefore many additional URLs can be utilized with the game distribution hub. Conversely, in optional embodiments, a single URL can be used for access by all prospective contestants, for all games. In yet an additional alternative embodiment, the clearing house hub can be provisioned to access outside databases, such as databases maintained by law enforcement agencies, and then to cross-reference information in internal databases (e.g., information collected from prospective game contestants) against information contained in such law enforcement databases, in order to screen prospective game contestants according to criteria described elsewhere herein.

If the participant wins, the winnings will be transferred directly to the participant's bank account and or credit or debit card or to an electronic wallet located on the gaming system. Optionally, the participant is issued a receipt and the database retains a copy of the receipt or transfers it to a second database. If the participant spends more money than he or she should, the participant will be locked out of the game for a period of time. This will be defined by either the participant's own spending limits or built-in spending limits. The participant can choose to delete or deactivate his/her profile.

In certain unique (but still alternative) embodiments, in person, cash payment mechanisms are provided which allow cash payment at a brick-and-mortar transaction location, even when game play is conducted on the internet (i.e., online) or on a private electronic network. For example, in one particularly distinctive embodiment, “lottery payment proof” (or “lottery play”) cards can be sold at brick-and-mortar locations and used, in lieu of other payment forms (such as wires or electronic checks), to demonstrate that a prospective game player (or contestant) has paid for the right to play a game or lottery or sweepstakes. In one specific version of such an embodiment, a game contestant may purchase a physical game or lottery ticket with cash. The physical ticket can include a code covered by a scratch off film, which the game contestant removes (e.g., using a coin or finger nail or similar method) to reveal the code. The code can then be supplied to a Game Provider hub, which is then cross-checked against a database. In other words, the entry of the code confirms to the Game Provider that the game play has been paid for with cash, and the Game Provider can thereafter be compensated by the ticket seller (who received the cash payment) such as through electronic transfer of funds. The ticket seller, in such instance, preferably retains a portion of the ticket sales price as a commission to compensate the ticket seller for the effort involved in processing and enabling the transaction. In such a method, a convenience store may sell a scratch-off ticket in a state such as Arizona (for example) to a prospective game contestant. The code is then revealed by scratching off the scratch-off film and thereafter used to prove payment for game play by entering the code into a web interface of a mobile device (or other web or network accessible device) which, in turn, accesses a Game Provider's clearing house hub in a far away locale, such as Florida (for example). Verification of the code authenticity and value amount can be obtained by accessing an additional database (such as a banking or governmental lottery database) or via parsing data stored on the Game Provider's database (on physical servers or in a cloud). To facilitate efficacy of such an embodiment, lottery payment proof cards can be sold in specific monetary denominations, such as for example representing a play-purchase amount of $5, $10, and $20 respectively. In such an embodiment, the hidden code on the scratch off ticket (in this optional embodiment) will correspond to the monetary amount paid at the brick-and-mortar location. This may be accomplished through various means such as by recording each code as having the pre-determining monetary (e.g., dollar) value in a database, or by assigning numerical code ranges to have specific monetary values. For example, codes beginning with the numeral (or integer) 1 may be assigned a value of $5 dollars (or other pre-determined value), whereas codes beginning with the numeral (or integer) 3 will have a different predetermined monetary value (such as $10), and so forth. Of course, the number of integers in the code can be unlimited to account for increasing numbers of tickets sold to game contestants. For example, the initial tickets could have 5 “figures” (e.g., 1xxxx) but as player participation increases, the number of figures in the code can be increased (e.g., to 1xxxxx, 1xxxxxx, 1xxxxxxx, etc.), and the advantages described herein still obtained, so long as the first integer code system is maintained or adhered to.

In yet additional alternative embodiments, if a unique serial number is printed on a physical ticket, in addition to the code under a scratch-off film, a unique monetary amount can be assigned to each and any code. This can be accomplished by a merchant at a brick-and-mortar location accepting a monetary payment selected by the game contestant (i.e., payor), then entering that payment amount into a database, while also entering the serial number displayed on the ticket into the database so that the monetary value and serial number are affiliated (the serial number can either be visible or revealed by an additional scratch off film for security purposes). The serial number of the ticket will be unique and will have already been affiliated with the hidden code printed on the ticket (i.e., under the scratch off material). Accordingly, when the code is thereafter entered into a Game Provider database, the code can be cross-referenced to find its matching serial number, and then the serial number searched (within a database) to determine the monetary amount which was affiliated with it by the payee that was paid at the brick-and-mortar location. Using such methods, paper costs can be saved (among other benefits), because if a monetary payment requirement is changed in connection with a Game Provider game, new physical tickets will not need to be printed. The new monetary amounts can be simply assigned to the existing tickets with unique serial numbers when the game contestant (payee) pays for the ticket at the brick-and-mortar payment location (such unique amount then being assigned to the code). Of course, data sharing is accomplished by transmitting code, payment, and serial number data across networks to and/or from the payee, Game Provider, lottery entity, and/or governmental entity, etc.

In some of the above or other embodiments, there is also provided a unique lottery, in which electronic payment is accepted (e.g., credit card payment). In such a lottery, lottery play is monitored so that frequent players can be identified. If players play too often, they can be warned and/or play suspended for selected times. Frequency of play acceptability can be the same criteria for all players, or based on salary and/or credit history.

Additional embodiments of various related inventions are described below.

In at least one embodiment, a game administration method is provided comprising the steps of: a game contestant accessing an electronic game provider hub by electronically submitting identifying information and payment information to the game provider hub; the game provider hub verifying the identity of the game contestant and screening the game contestant for criteria to permit or deny entry into a gaming system for participating in game play; and wherein when the game contestant is approved for game play, the game contestant is granted access to a plurality of lotteries, sweepstakes, or other games, administered by an electronic game provider.

In a preferred but optional embodiment, the game provider hub is a single hub and the plurality of lotteries, sweepstakes, or other games are located at multiple locations in or around the United States or world.

In another preferred but optional embodiment, the game contestant accesses the game provider hub by a mobile phone application or by a website.

In another preferred but optional embodiment, the game contestant accesses the game provider hub by entering into a web browser one or more URLs of the game provider corresponding to one or more games.

In another preferred but optional embodiment, the game provider makes the one or more URLs available to the game contestant by publicizing the URLs in promotional media.

In another preferred but optional embodiment, the game contestant pays for game play by using one or more of a credit card, a debit card, a payment provider, or digital currency.

In another preferred but optional embodiment, the game contestant pays for game play by purchasing, preferably (but optionally) with cash, a physical game play ticket containing a code, and wherein the code is provided to the game provider hub to prove payment for the game play.

In another preferred but optional embodiment, when the game contestant wins during game play, the game contestant receives payment by recording a credit balance, by direct transfer to the game contestant's bank, credit card or debit accounts, by cash or digital currency, or with hard goods.

In another preferred but optional embodiment, the game administration method utilizes a cloud-based network, including data transmission and storage mechanisms.

In another preferred but optional embodiment, lotteries, sweepstakes, or other games are delivered by one or more cloud-based servers including one or more cloud-based databases.

In another preferred but optional embodiment, the game provider and game provider hub serve as a clearing house, with third-party game providers being provided electronic access to the game provider hub.

In another preferred but optional embodiment, the game provider hub defines spending or game play limits for the game contestant. When the spending limit is exceeded, or if it is determined that the game contestant has debts elsewhere, in another preferred but optional embodiment, the game contestant can be locked out of the game for a period of time.

In another preferred but optional embodiment, lotteries are monitored to identify frequent players, who can be warned or have lottery play suspended for selected times. In preferred (but optional) embodiments, criteria for frequency of play acceptability can be the same for all players or based on salary or credit history.

In another preferred but optional embodiment, the game contestant is screened by comparing the identifying information and payment information to information in databases maintained by one or more of the game provider, government or legal authorities, or credit card providers.

In other preferred but optional embodiments, when the game contestant is approved for game play, a player profile is established, which the game contestant can utilize to obtain access to game play and which enables the game provider to monitor the game contestant's game play.

In another embodiment, a game entry and access granting apparatus is provided comprising: a game network comprising data transmission equipment, at least one data processor, and at least one data storage device; the game network including hardware and/or software configured to control the game network such that it operates to provide a game network access granting hub on which the following method steps are performed: a game contestant accessing an electronic game provider hub by electronically submitting identifying information and payment information to the game provider hub; the game provider hub verifying the true identity of the game contestant and screening the game contestant for criteria to permit or deny entry into a gaming system for participating in game play; and wherein when the game contestant is approved for game play, the game contestant is granted access to a plurality of lotteries, sweepstakes, or other games, administered by an electronic game provider.

In a preferred but optional embodiment of the game entry and access granting apparatus, the true identity of the game contestant is tracked and recorded during game play of the plurality of lotteries, sweepstakes, or other games such that winnings attributable to a winner of the plurality of lotteries, sweepstakes, or other games are attributed to the true identity of a contestant accessing the game entry and access granting apparatus.

Certain examples of the invention are now described below with respect to certain non-limiting embodiments thereof as illustrated in the following drawings wherein:

### BRIEF DESCRIPTION OF DRAWINGS

FIG. 1 schematically illustrates one embodiment of an example lottery system according to the subject invention.

FIG. 2 schematically illustrates one method or process of creating or generating lottery tickets according to one non-limiting embodiment of the subject invention.

FIG. 3 illustrates an example screenshot of a television program or web production of a broadcast or publicized lottery according to one embodiment of the subject invention. Seven additional figures are provided which illustrate example operations or methods or configurations of certain non-limiting embodiments of the invention, as well as certain example components and functions thereof.

FIG. 4A illustrates example operations or methods or configurations of certain non-limiting embodiments of the invention, as well as certain example components and functions thereof.

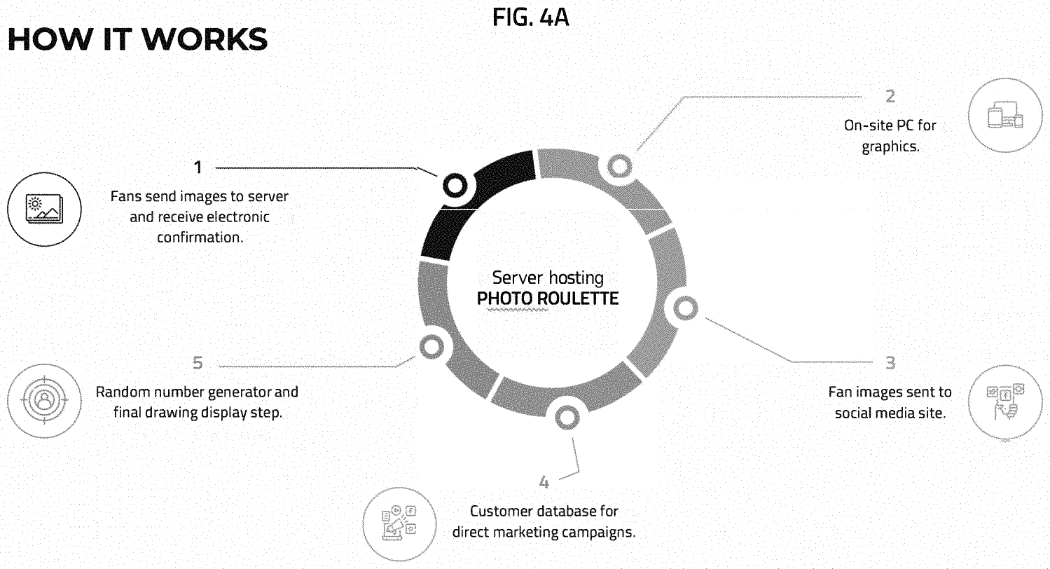

FIG. 4B illustrates example operations or methods or configurations of certain non-limiting embodiments of the invention, as well as certain example components and functions thereof.

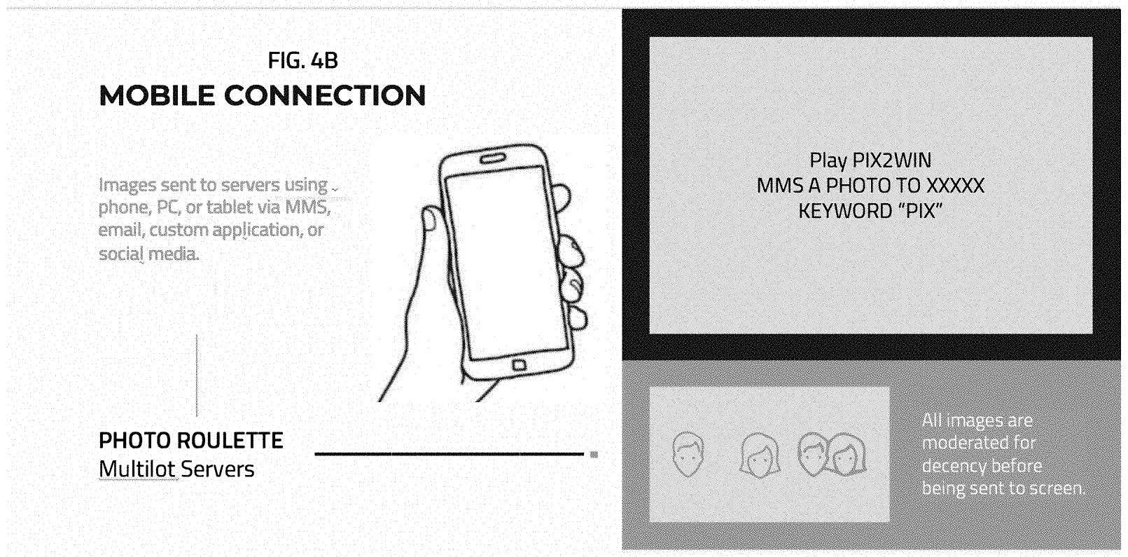

FIG. 4C illustrates example operations or methods or configurations of certain non-limiting embodiments of the invention, as well as certain example components and functions thereof.

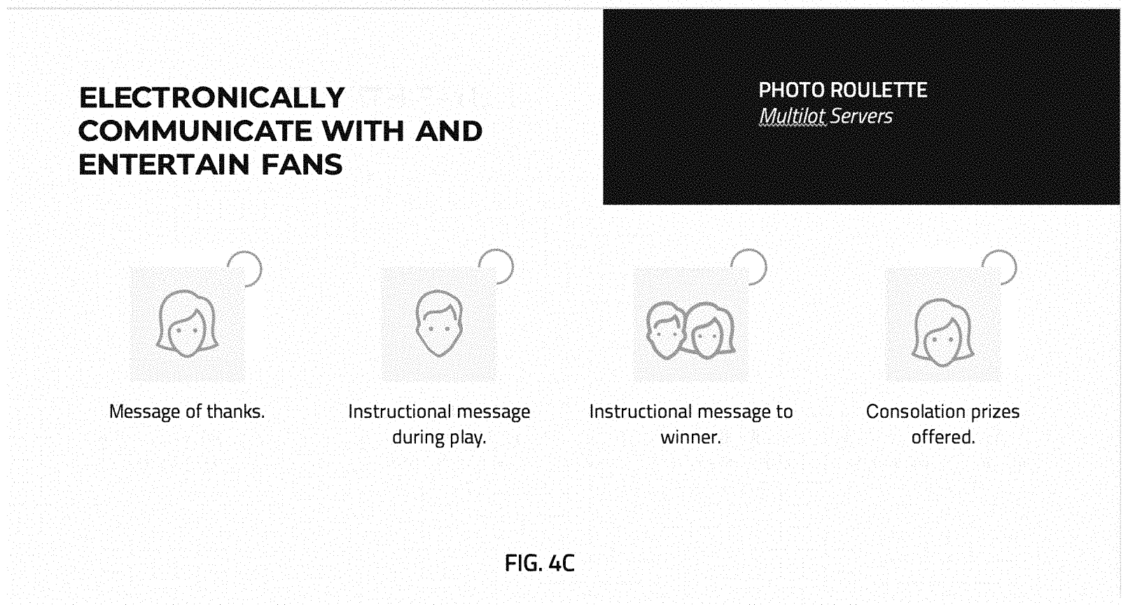

FIG. 4D illustrates example operations or methods or configurations of certain non-limiting embodiments of the invention, as well as certain example components and functions thereof.

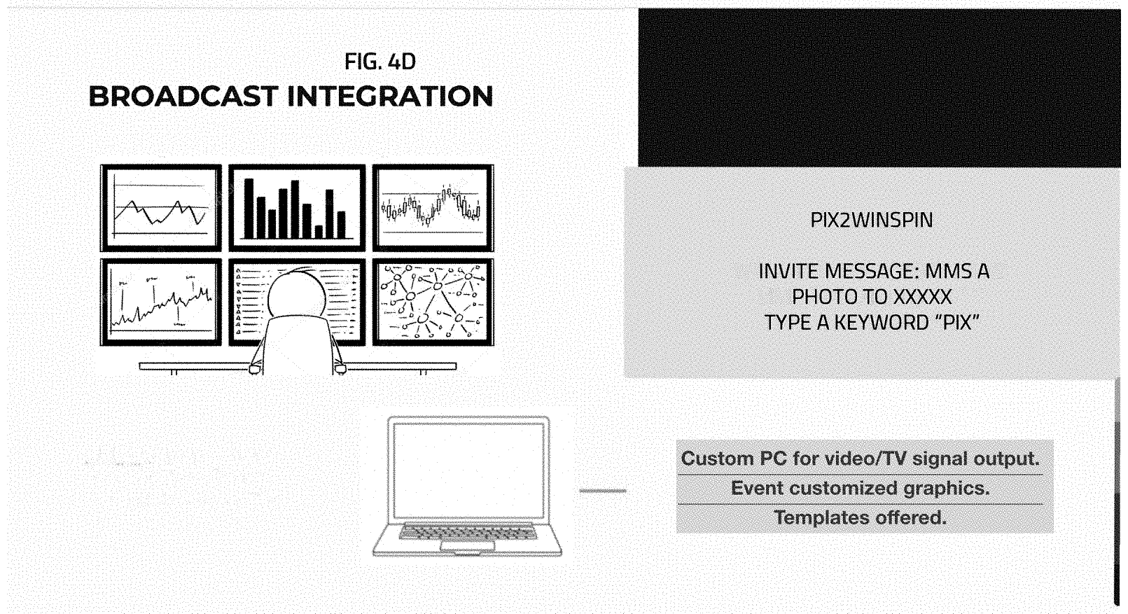

FIG. 4E illustrates example operations or methods or configurations of certain non-limiting embodiments of the invention, as well as certain example components and functions thereof.

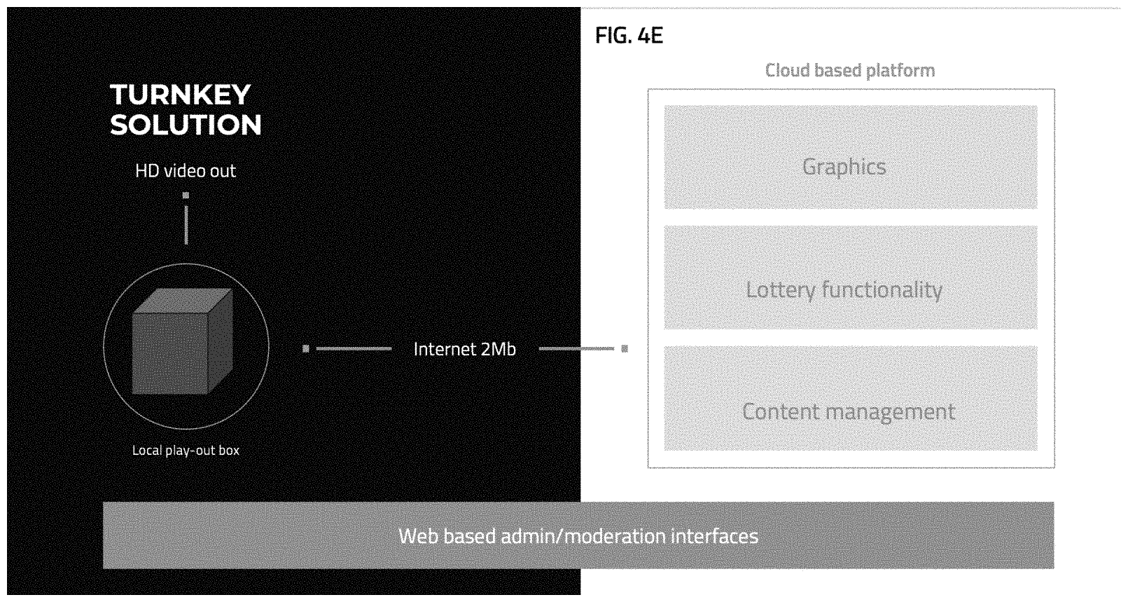

FIG. 4F illustrates example operations or methods or configurations of certain non-limiting embodiments of the invention, as well as certain example components and functions thereof.

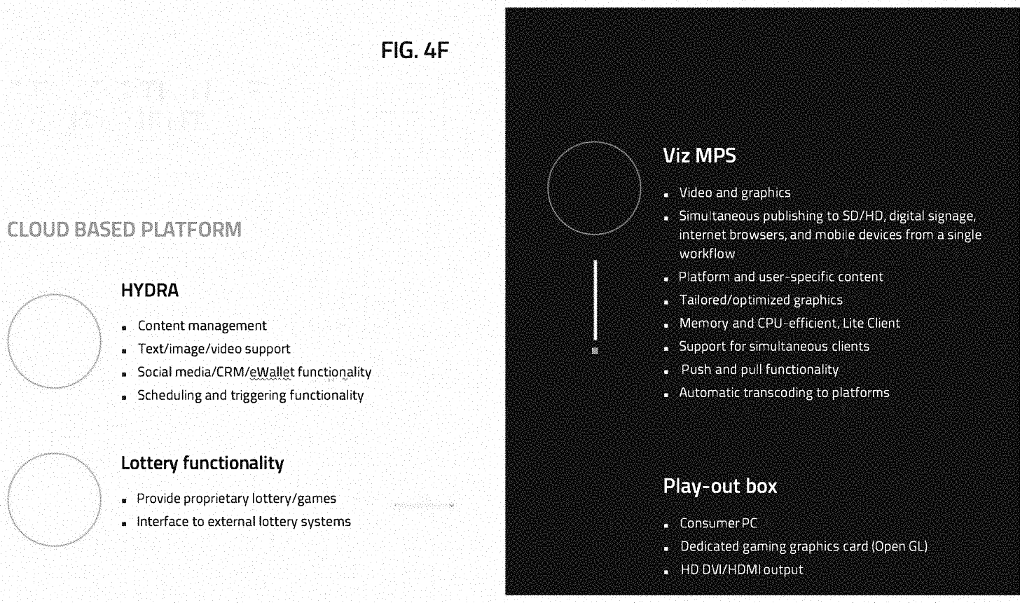

FIG. 4G illustrates example operations or methods or configurations of certain non-limiting embodiments of the invention, as well as certain example components and functions thereof.

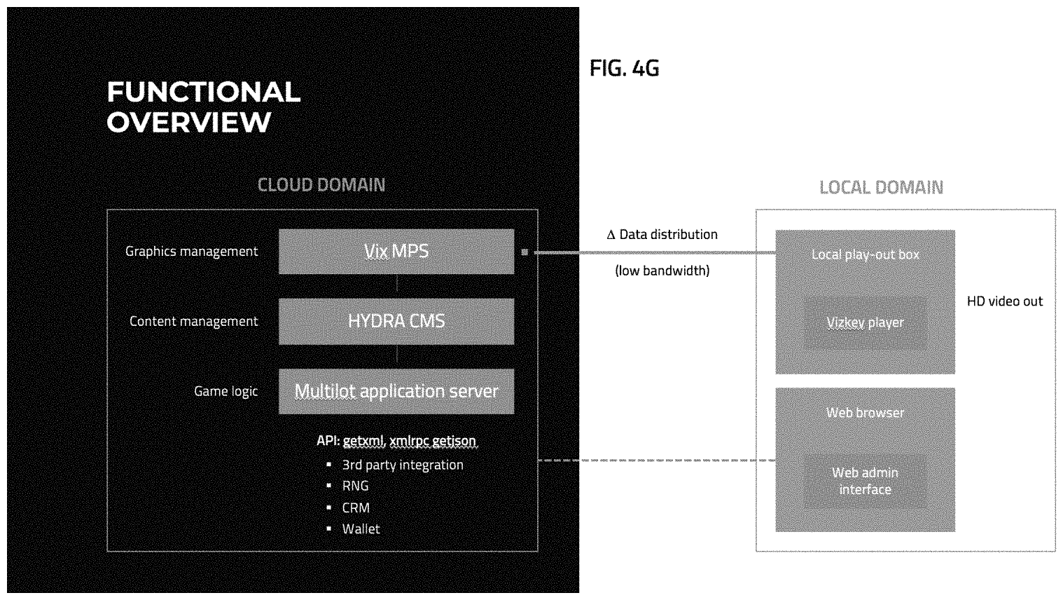

FIG. 5 schematically illustrates one embodiment of example apparatus, systems, and methods which embody, generate, synthesize, and/or deliver real and/or virtual world experiences.

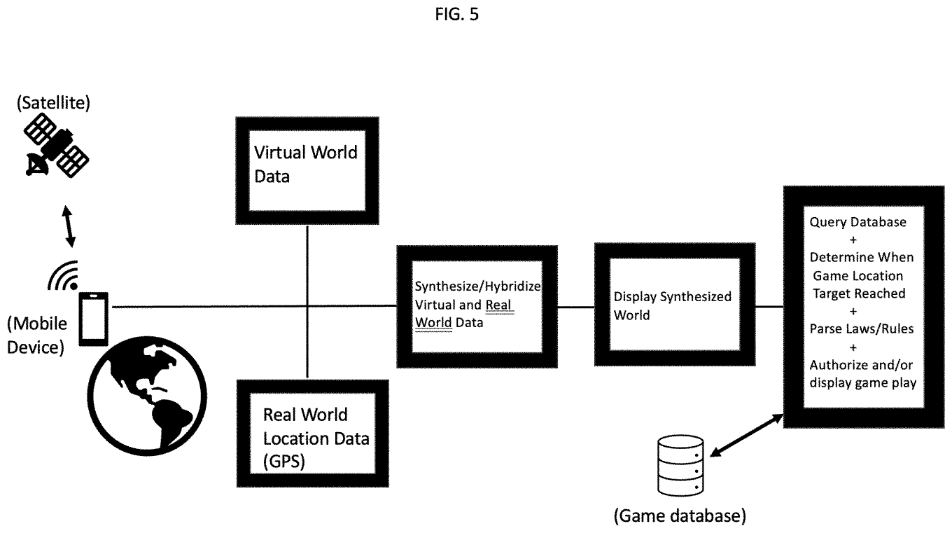

### DETAILED DESCRIPTION OF CERTAIN EMBODIMENTS

For a more complete understanding of the present invention, reference is now made to the following description of various illustrative and non-limiting embodiments thereof, taken in conjunction with the accompanying drawings in which like reference numbers indicate like features.

Addressing one or more of the above-described drawbacks or needs in the lottery arts (or other drawbacks or needs not specifically described herein), at least one embodiment of the subject invention comprises a unique lottery ticket comprised of a photograph or other digital image submitted by a contestant in combination with payment for lottery participation. Such an image and/or payment information is compiled and/or encrypted to form a secure information capsule which serves as a lottery ticket. When such a capsule is encrypted, the information contained in the lottery ticket (including the identity of the contestant, the image, and possibly other information) is secured from unauthorized access and therefore aids in preventing tampering with lottery integrity. Because numerous other types of information may be provided in connection with a digital image (e.g., at the time of purchase of lottery participation), such as a contestant's name, address, phone number, sex, birth date, date/time of ticket purchase, etc., such categories of information, including payment information, are periodically referred to herein as, and are intended within the scope of this document to be, synonymous with the term “contestant information”.

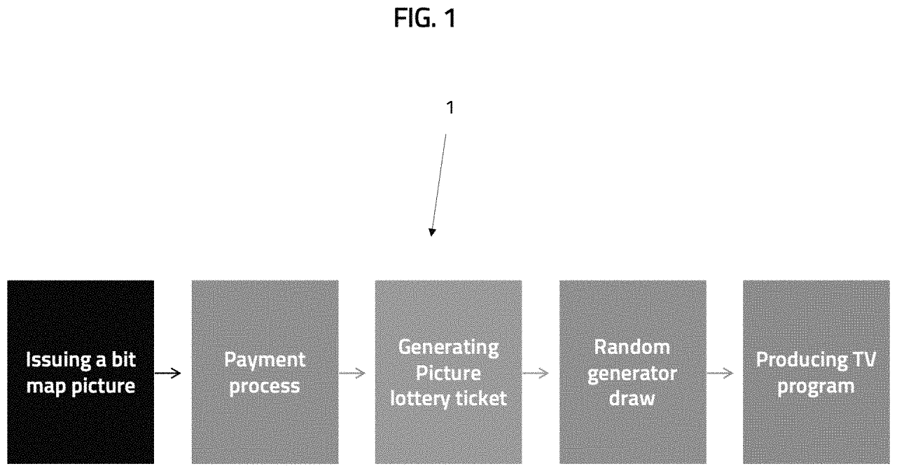

Referring now to FIG. 1, a non-limiting, example embodiment of a lottery system which utilizes such a lottery ticket (e.g., comprised of a digital image and contestant information compiled or encrypted to form an information capsule) is schematically depicted therein. Generally speaking, such a lottery system 1 includes five main stages or phases which begin with entry of a contestant into the lottery and terminate with the selection of a lottery winner and the broadcast or publication of such lottery winner on a television program, webcast, website, or the like.

More specifically, the lottery begins with phase 1 where the prospective lottery contestant submits a digital image to the lottery provider. Such digital image may be taken or captured using a cellular phone (with a built-in camera) or may be taken with a conventional camera and then uploaded to a computer or cellular phone for submission. Similarly, a scanner may be used to create a digital image or an image may simply be obtained from third party sources or even authored via software programs such as Adobe Acrobat, Photoshop, or Microsoft's Paint application. In still another example, lottery kiosks may be provided in public locations, such as grocery or convenience stores, with such kiosks including cameras and appropriate data or internet connections for capturing and submitting digital images. Regardless of how the image is created or captured (and regardless of the type of image file which is employed, for example, a “.bmp” or “.jpg” or “.tiff” type file), the image is ultimately submitted to the lottery provider or administrator using suitable methods or mechanisms. These may include, but are not limited to, via MMS message, internet (e.g., via email), proprietary software interface (e.g., contained or downloaded onto a computer, hand held device, or mobile phone), or via the above-described kiosk, for example. In at least one embodiment (not intended to be limiting to the invention), once an image is submitted to the lottery provider, the image is stored on lottery servers in association with a unique user profile linked or associated with the lottery contestant (e.g., created simultaneous with, prior to, or after the submission of a suitable image).

Certain embodiments may utilize social media or networking sites, such as Linkedln™ Facebook™, and Twitter™ for entry. In those embodiments one unique method of entry may be accomplished by a participant applying a hashtag or pound sign (#) to a message and posting the message to a social media platform. The hashtag that results in game entry may be defined by an administrator such as an event sponsor, a promoter, or the game provider. For example, the entry hashtag could be defined to be the name of a promoter and could appear as: #PromoterName. In a further non-limiting example, a promoter may desire to promote the name of a product. The promoter is enabled to define the entry hashtag to be a product name. In that case the entry hashtag could appear as: #PromoterProductName. The game, lottery, or sweepstakes system mines or accesses data from the social media platform and may be configured to search for the entry hashtag (alternatively, in some embodiments, the data may be pushed if the hashtag operates as an entry command). This mining may be accomplished by a local or cloud-based network. Upon finding an entry hashtag the game, lottery, or sweepstakes system may enter the corresponding participant into the game, lottery, or sweepstakes.

In phase 2, subsequent or simultaneous with phase 1 (or even prior thereto), a lottery contestant submits payment for lottery participation (e.g., payment for entry into the lottery, issuance of the ticket, and the chance at winning prizes or money). Such payment can be completed using functionalities or services offered by contestants' mobile operators where the owners of the mobile phones (or cellular phones) are charged or billed through their mobile subscription either as a credit, debit, or via deduction from a pre-paid account (e.g., a pre-paid SIM card). Alternative payment options include cyber currency—such as Bitcoin—or may even include conventional cash or check payments. Check payments may be made by scanning or taking photographs of a signed check (or other legal monetary instrument) and then transmitting or uploading to obtained image to the lottery provider or to an authorized bank or other account holder or manager. In still other embodiments, it is envisioned that a participant could be provided with a location to submit a physical, paper check (or other physical currency). This billing or debiting (or at least the recording of the transaction) may occur simultaneous with an MMS image submission to the lottery operator, for example. In other example embodiments, user profiles may be linked to payment services or options such as merchant accounts, credit or debit cards, or PAYPAL type accounts (e.g., such that when an image is submitted to the lottery administrator, payment is automatically completed via payment services linked to the user profile). However payment is made, in exemplary embodiments of the invention, whenever an image is submitted to the lottery provider (or when the lottery provider processes or accepts a submitted image), a valid payment is registered and a lottery ticket purchase (or lottery entry) is fulfilled. Thereafter, in phase 3, the process of creating a picture or image type lottery ticket is begun.

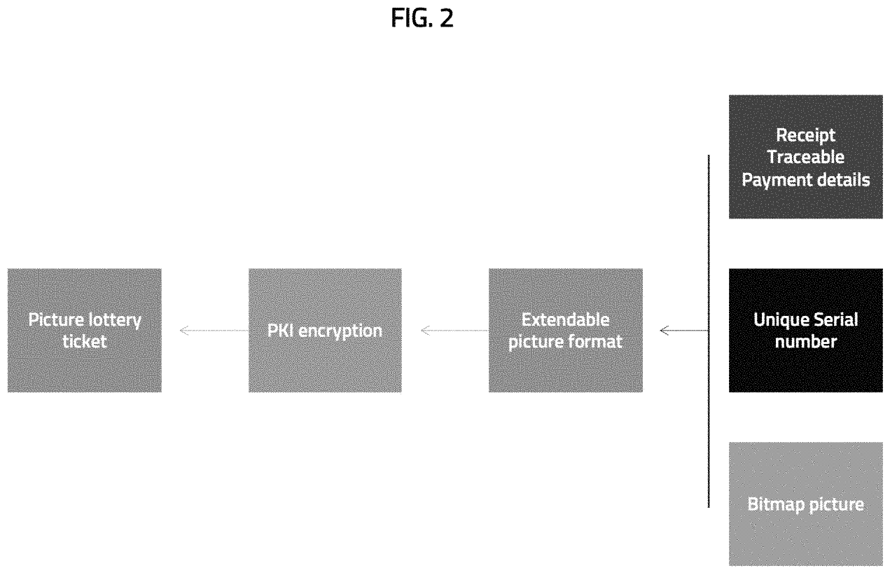

In particular, during phase 3, the image file submitted by the lottery contestant is converted into a lottery ticket, as schematically illustrated in FIG. 2, which, optionally, can be used in an existing or conventional lottery process and infrastructure. This conversion, in preferred (but not necessarily all) embodiments, includes a combination or compilation of the digital image with contestant information, which preferably includes payment information, as defined herein above. Generally speaking, each lottery ticket (e.g., created from a digital image, etc.) converted or created results in a self-contained information capsule (e.g., created or stored as a “.lot” file with associated MIME type(s) to process the file), which, in preferred embodiments, carries all (or at least some) information necessary to secure lottery ticket integrity and to re-generate the originally submitted lottery picture or image (and/or contestant information). Further, in at least some embodiments, each information capsule or lottery ticket created will be linked to the users (i.e., image issuer's or lottery contestant's) unique personal profile.

In certain embodiments, when a picture or image is received from an issuer (i.e., a lottery contestant), the lottery provider or administrator charges a fee to convert the image into a lottery ticket. In preferred embodiments, traceable banking information—for example routing numbers or information and/or clearing house numbers—will be integrated in whole or in part into the lottery ticket.

Also (in at least some embodiments) during phase 3, to ensure, among other things, that each lottery ticket has a unique value or identifier, a serial number will be generated and integrated into or associated with the lottery ticket. Such a serial number may be generated randomly or as a result of data provided by the lottery contestant e.g., derived from digital image information and/or contestant information.

In one particularly unique embodiment, a lottery or sweepstakes is provided which utilizes the digital image submitted to generate a unique entry number derived from data present in the digital image. For example, the color patterns or color saturation within the image can be analyzed and unique numbers thereby generated from the unique color patterns or color saturation values found in each image. This can be done in combination with data sets derived also from the number of objects displayed within the image, or from the shape(s) of the objects displayed within the image. Accordingly, because each image (e.g., each personal photograph) submitted will be unique, each entry number derived from the image will be unique. These unique numbers obtained, derived from the qualities of each unique photograph, may be combined with the image and other contestant information to form a digital image lottery ticket for each lottery entrant. Alternatively, the derived data sets can be converted into a unique individual lottery number, sweepstakes number, or serial number to be used as the unique entry identifier itself (preferably still associated with a digital image). In some embodiments, software can be utilized to more quickly evaluate such photo derived entry identifiers for the purposes of most quickly matching the numbers to drawn (or otherwise selected) winning entry numbers, for more efficient winner selection or determination. In certain embodiments of the invention (but not necessarily all embodiments), open source extendable image formats are used for compressing or packing information, but in some cases, non-open source (for example, proprietary) formats will be used. In embodiments in which non-open source or proprietary formats are used, such use may be employed for the purpose of further uniquely identifying images or generated lottery tickets. Such use, in this regard, may provide security or integrity to the lottery system or method by indicating the presence of or by providing necessary lottery information. Although conventional PKI type encryption may be used to encrypt information capsules and/or tickets and/or contestant information (e.g., so that the tickets or information capsules, etc. can only be opened or accessed by authorized persons to thereby provide additional integrity or security to the lottery system), it is contemplated, of course, that other encryption types or methods may be used (or that other data securitization types or methods, exclusive of encryption, may be used) regardless of whether in existence at the time of the present application for patent.

Of course, each of these steps or processes just described related to encryption, compilation of data, and/or otherwise related to the creation of the information capsule or lottery ticket (whether or not encrypted at this stage or later or not at all) may be performed by the lottery contestant rather than the entity administering the lottery (or such entity's equipment or agent), or by some combination thereof. For example, software may be provided either preloaded into computers or mobile devices or made available as downloads (e.g., as an iPhone software application). Alternatively, all of the necessary software may be hosted in “the cloud” to minimize hardware cost, install, and storage requirements. In such cases, the contestant could access the necessary software using a link provided on a mobile device, which is either located by navigating the world wide web or because it is received by email, text message, or other messaging mechanism or type. However provided, and regardless of where hosted or stored (or operated), such software could be used by a lottery contestant to pre-encrypt image and contestant information or to otherwise create a valid, secure lottery ticket (e.g., or information capsule) prior to or simultaneous with submission of such to the entity administering the lottery (whether or not such lottery ticket or information capsule is encrypted, by compiling or combining appropriate data or information).

In phase 4 or the lottery draw phase, a lottery drawing will take place in which lottery entrants will either be selected to advance to intermediate or advancement phases of the lottery and/or a final lottery winner or winners will be selected. In certain example (but non-limiting) embodiments, a lottery draw is conducted utilizing an approved (and preferably secure) random number generator and/or lottery draw machine supplied by one of a number of possible vendors.

In certain but not all embodiments, the draw is completed in several rounds such as “qualification”, “advancement”, and “final” rounds. In an example of one of such embodiments, a first round is completed or performed to select a plurality of lottery tickets which, as winners of an initial lottery stage (or “qualification draw”), enter or proceed to the next levels or stages of the lottery. In such later stages, further draws are completed which select or determine winners to proceed to additional or a final stage(s). As described in more detail below, one or more (or all) of such draws or levels (e.g., including pictures or images of the contestants advancing) can be broadcast (or integrated into an existing broadcast) on a television program or otherwise publicized such as on a webcast or website. Further, the various levels of draw may be completed or initiated prior to a television broadcast (for example) or, alternatively, as a live component of a television program (e.g., using pre-moderated images or photographs from or comprising the lottery tickets).

In some embodiments of the inventive lottery methods and/or systems where moderation of images or photographs is employed (e.g., because of local laws regulations or ethical standards), the approval or moderation process is conducted by human moderators. More particularly, such moderators will review and adjudge the submitted, selected, or drawn pictures or images to ensure compliance to regulatory and decency issues (i.e., which will typically be different from market to market and from application to application). If a picture is not compliant or is otherwise not acceptable (e.g., as decided by moderators or other mechanism), it can be exchanged or replaced with a dummy placeholder picture or other generic image for use in the associated television program or other form of lottery publication or broadcast.

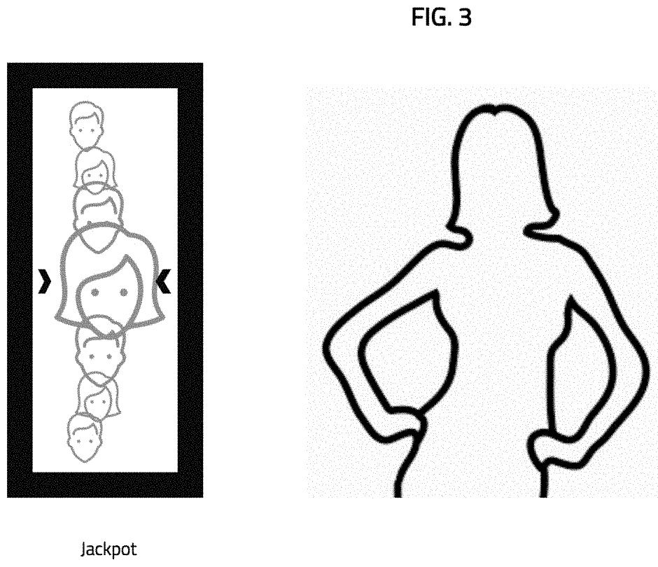

As contemplated by the Applicant herein, at least one purpose of the television broadcast or other type broadcast or publication of the subject lotteries is to provide a visual, more engaging component to the herein described lottery systems and methods. In this regard, by broadcasting or publicizing images or photographs submitted by lottery contestants (see FIG. 3, for example), participation in such lotteries and/or viewership of such lotteries is expected to improve (e.g., because of the prospect of viewing a neighbor's or friend's or one's own submitted image or photograph) thereby bringing additional revenue to such lotteries. Although such goal is believed to be best accomplished by broadcasting or publicizing (visually) multiple levels or stages of the herein described lotteries, it is, of course, contemplated that no stages or only one stage of such lotteries are publicized or broadcast (with the photograph or image information otherwise providing additional verification of the identity of the lottery contestant, among other benefits, for example).

In addition to the other benefits and advantages of the lottery tickets, methods, and systems described herein, it is noted that by utilizing an electronic contestant entry procedure and/or process and/or ticket, in certain embodiments, new lotteries can be organized and/or initiated in short periods of time. Moreover, previously organized or initiated lotteries can be completed in condensed time frames. For example, in certain embodiments, new lotteries can be announced to prospective contestants via television commercials, web broadcasts, SMS texts, or MMS messages, and the lotteries can be completed quickly or within some compressed time frame thereafter. For example, prospective participants generally interested in lotteries could subscribe to notification services which will send SMS or MMS messages (or emails) to such subscribers announcing the creation or initiation of new lotteries. Utilizing the technologies including tickets, methods, and systems described herein, such announced or initiated lotteries could be joined or entered virtually instantaneously (e.g., without requiring a trip to a remote lottery ticket purchase center) such as by return MMS message or email message (e.g., with included image and/or payment information as described herein above).

In at least one example embodiment, games can be provided which can be played contemporaneously with the attendance of a live event, such as a sporting event or musical performance (or trade show). In at least one such example embodiment, potential game participants attending a live event, such as a baseball game, are displayed an advertisement on stadium screens and through such advertisements in the stadium, are invited to enter into a competition or game to win a prize. In this non-limiting example, entrants are not charged a game entry fee for participating in the game or contest. Instead, hopeful participants can simply send a photograph to an identified “short code” (or to a phone number or email address, for example) by the invited method, i.e., via conventional MMS message, for example. Although standard earner MMS messaging or data may be charged, no other costs would be charged to the participants. At some later time during the event, the stadium screens will display the selection process of the prize winner or winners. For example, the photographs of the entrants may be displayed in a photo carousel or on a spinning photo-wheel, displaying numerous entrant photographs, that spins around and stops at the winning photograph. Photographs of entrants may be displayed (concurrently or via alternating displays)—such as cascaded—in any other aesthetically desirable way, of course. A financial sponsor or sponsors of the games can structure the game so that participants are sent a link to a social networking page (e.g., to a Facebook page) or to an internet web-page where they can see their photographs combined with logos representative or associated with the events they attended and/or the sponsors of the game.

In the live events described, games may be delivered or otherwise provided via cloud-based software. Cloud servers, in such example embodiments, may be operated and owned by the game provider, or the game provider may use the existing cloud server services of existing third party providers (such as cloud storage provided by companies such as IBM, Amazon, Google, Microsoft, and the like). Alternatively, the game provider may install physical servers at or near the event locations, or even in mobile vehicles, such as temperature controlled cargo vehicles carrying their own power supplies and game servers. Regardless of where the software is hosted (e.g., locally or in the cloud), the games may be streamable or downloadable by the lottery participant or by the event sponsor.

In certain of such embodiments (but not all of such embodiments), a game sponsor's name and/or logo will be featured or otherwise displayed on the stadium screens and/or also in the confirmation messages participants receive on their mobile phones or similar communications devices. Coupons (or other redeemable certificate types), advertisements, and/or other marketing information or participation rewards may also be sent. Similarly, surveys (or other sponsor related inquiries) could be sent, for example, with rewards or other compensation possibly provided to the participants which actually complete the surveys.

### First Example (Non-Limiting) Steps in One Method or System of Administering an Embodiment of the Herein Described Games or Lotteries

### Registering the Customer

1. In certain embodiments, for a customer to enter the lottery, the customer may provide or register one or more of the following details:
   Name
   Phone number
   E-mail
   Address
   Birth date or age
      Of course, in some embodiments, only some of the example identifying detail listed above may be provided. For example, a phone number and name may be the only information given and may be collected by way of receipt of an SMS or other message from the lottery participant.
2. Terms of use may be presented or displayed and may be required to be accepted by the customer prior to issuance or acceptance of lottery ticket.
3. Information registered in the database may be encrypted.

### II. Taking the Picture

1. The customer takes a digital picture utilizing a camera-phone or ordinary digital camera.
   -or-
2. The customer scans an ordinary photo or image and uploads the photo or image to his/her phone or computer.
   -or-
3. The customer uses an existing digital image created by the customer or any third party or other source.
4. The customer utilizes a publicly available lottery kiosk to create a digital image.

### III. Sending the Digital Image or Picture

1. The digital image is sent to the lottery server by using a mobile phone, tablet, or similar device's MMS utility (or installed software “app” or application).
   -or-
2. The digital image is sent to the lottery server by e-mail or instant message (“IM”) or via an internet chat service or via satellite connection (for instance from a mobile phone or electronic tablet) or by similar electronic mechanism or means (e.g., from a social networking site or web site interface).
   -or-
3. The digital image is sent to the lottery server using a lottery kiosk.

### IV. Paying

1. The customer pays in advance by way of an existing, conventional payment and debit solution for mobile phones.
   -or-
2. The customer has the cost of the lottery ticket and the cost of the data transfer added to the customer's phone bill.
   -or-
3. The customer has the cost of the lottery ticket (e.g., and possibly the cost of the data transfer) deducted from his or her pre-paid mobile phone card (e.g., instantly).
   -or-
4. The customer pays via the internet by way of bank transfer.
   -or-
5. The customer pays via the internet by way of debit card or credit card.
   -or-
6. The customer pre- pays the lottery ticket in a kiosk.

### V. Receiving Payment

1. When payment is received by way of an existing payment and debit solution for mobile phones, the payment and its amount may be encrypted (but is not required to be) and then registered and linked to the customer's profile in the database.
   -or-
2. When payment is received or confirmed by the customer's mobile phone earner by way of deduction from the customers pre-paid mobile phone card, the payment and its amount may be encrypted and/or registered and linked to the customer's profile in the database.
   -or-
3. When payment via internet is confirmed by a credible or trusted third party (i.e., a bank, credit card merchant, PAYPAL, etc.), the payment (optionally) may be encrypted and/or then registered and linked to the customer's profile in the data base.
   -or-
4. When payment is received or confirmed by the customer's mobile phone earner by adding the cost to the customer's phone bill, the payment and its amount may (optionally) be encrypted and/or then registered and linked to the customer's profile in the database.

### VI. Receiving the Image

1. Upon receipt of an image at the lottery server (or at a later time prior to broadcast or publication, for example), the image may be manually checked in order to make sure it complies with laws and/or general ethical standards.
2. If an image is, for some reason, not in compliance with current laws or ethical standards (e.g., because it is obscene, insulting in nature, etc.), the image may be replaced with a standard, computer generated image.

### VII. Sending Receipt

1. The customer may be sent a receipt by SMS text to the number registered in the database, and/or the number the image was sent from, as a confirmation of the transaction.
   -or-
2. The customer may be sent an MMS message as a receipt and confirmation of the transaction.
   -and/or-
3. If the image submitted for processing as a lottery entry was deemed unfit for any reason (e.g., unlawful for public broadcast), the customer may be notified by way of SMS or MMS or other mechanism.

### VIII. Registering the Picture, Creating the Lottery Ticket

1. Upon receipt of an image at the lottery server (or, in other embodiments, prior to submitting the image to the lottery administrator), the image may be encrypted.
2. The encrypted image is linked to the payment, the amount and origin of the payment (and possibly other contestant information, if desired) and may be assigned and linked to a unique sequence number. The encrypted image serves as the actual lottery ticket.
3. The lottery ticket created in step 2 above is linked to the customer's profile.
4. The received image is combined with contestant information, payment details, and a unique sequence number and is encrypted to form an information capsule which serves as an actual lottery ticket.
   -or-
5. The received image is combined with contestant information, payment details, and a unique sequence number which serves as an actual lottery ticket (i.e., without performing an encryption step or forming an information capsule).

### IX. The Draw

1. A random number generator generates a unique random number for every participant's customer profile. Alternatively, a unique number is assigned to each lottery ticket at an earlier time or during an earlier step such as when the image and payment are registered as a lottery ticket.
2. In an intermediate or lottery advancement (or final winner) stage, depending on the number of participants, the random number generator generates one or more numbers.
3. The numbers generated or “drawn” in step 2 are matched to lottery tickets generated or validated in earlier steps by matching such drawn numbers to the numbers assigned or affiliated with such lottery tickets in previous steps. The customers (or customer profiles) associated with such matches are deemed winners (e.g., final or advancement stage winners).
   -or-
4. Steps 2 and 3 can be repeated until the lottery provider (or operator) has a fitting or desired number of participants or images for the final winner draw (e.g., for display on the internet or for broadcast on television or on a stadium screen).
5. Optionally, images can be screened by moderators at this stage in addition to or instead of at earlier stages when or if there are large numbers of lottery participants.

### X. The Show

1. The television show or webcast or website will display images that represent entrants to the lottery.
2. One or more winners will be drawn by a random number generator.
3. The final winner (or intermediate stage winners) will be shown on a television show or webcast or website (or other desired public medium).
4. If the lottery ticket image was an MMS sent by mobile phone, the participant may be called on the phone number it was sent from, if no preferred alternate number was provided (or may be contacted by other mechanism or means).
5. The show (or webcast or internet display) may be broadcast or published as pre-recorded, with delay, or live.

### XI. The Confirmation of Winnings

1. As an optional service, informal confirmation of winnings may be given by SMS, e-mail or MMS.
2. Binding confirmation of winnings is given in writing.

### XII. Other Functions and Applications

1. In order to prevent money laundering or unhealthy and compulsive gambling habits from emerging, a database can be utilized to automatically track the gaming patterns of separate individuals. The database may be optionally created by collecting data from payment information submitted for each entrant. For example, if payment is received with a credit card or checking account, the use of the same account numbers can be monitored, tracked, and/or tallied. These numbers can be compared against a database of known or suspected abusers or money launderers. In other or similar embodiments, the names of entrants, or the identification of entrants, may be collected.
   -and/or-
2. If money laundering is detected, or if an unhealthy gambling pattern emerges, measures can be taken to prevent negative effects, such as by providing SMS, MMS or email warnings and advice to lottery entrants as well as by instituting restrictions for individual lottery participants. Moreover, restrictions and changes can be made to the lottery game itself. The lottery provider or operator may also, optionally, exclude individuals entirely, or report them to law enforcement officials.
   -and/or-
3. A database or other utility may be utilized, created in association with the operation of the lottery, so that the lottery game automatically enforces age limits or other terms or conditions of the specific lottery game itself (which may be changed from game to game or country to country or state to state, for example).

### Second Example (Non-Limiting) Steps in One Method or System of Administering an Embodiment of the Herein Described Games or Lotteries

### I. Registering the Customer

1. In certain embodiments, for a customer to enter the lottery, the customer may provide or register one or more of the following details:
   Name
   Phone number
   E-mail
   Address
   Birth date or age
      Of course, in some embodiments, only some of the example identifying detail listed above may be provided. For example, a phone number and name may be the only information given and may be collected by way of receipt of an SMS or other message from the lottery participant.
2. Terms of use may be presented or displayed and may be required to be accepted by the customer prior to issuance or acceptance of lottery ticket.
3. Information registered in the database may be encrypted.

### II. Taking the Picture

1. The customer takes a digital picture utilizing a camera-phone or ordinary digital camera.
   -or-
2. The customer scans an ordinary photo or image and uploads the photo or image to his/her phone or computer.
   -or-
3. The customer uses an existing digital image created by the customer or any third party or other source.
   -or-
4. The customer utilizes a publicly available lottery kiosk to create a digital image.

### III. Sending the Digital Image or Picture

1. The digital image is sent to the lottery server by using a mobile phone, tablet, or similar device's MMS utility (or installed software “app” or application).
   -or-
2. The digital image is sent to the lottery server by e-mail or instant message (“IM”) or via an internet chat service or via satellite connection (for instance from a mobile phone or electronic tablet) or by similar electronic mechanism or means (e.g., from a social networking site or web site interface).
   -or-
3. The digital image is sent to the lottery server using a lottery kiosk.

### IV. Receiving the Image

1. Upon receipt of an image at the lottery server (or at a later time prior to broadcast or publication, for example), the image may be manually checked in order to make sure it complies with laws and/or general ethical standards.
2. If an image is, for some reason, not in compliance with current laws or ethical standards (e.g., because it is obscene, insulting in nature, etc.), the image may be replaced with a standard, computer generated image.

### V. Sending Receipt

1. The customer may be sent a receipt by SMS text to the number registered in the database, and/or the number the image was sent from, as a confirmation of the transaction.
   -or-
2. The customer may be sent an MMS message as a receipt and confirmation of the transaction.
   -and/or-
3. If the image submitted for processing as a lottery entry was deemed unfit for any reason (e.g., unlawful for public broadcast), the customer may be notified by way of SMS or MMS or other mechanism.

### VI. Registering the Picture, Creating the Lottery Ticket

1. Upon receipt of an image at the lottery server (or, in other embodiments, prior to submitting the image to the lottery administrator), the image may be encrypted.
2. The encrypted image is linked to contestant information, if desired, and may be assigned and linked to a unique sequence number. The encrypted image serves as the actual lottery ticket.
3. The lottery ticket created in step 2 above is linked to the customer's profile.
4. The received image is combined with contestant information and a unique sequence number and is encrypted to form an information capsule which serves as an actual lottery ticket.
   -or-
5. The received image is combined with contestant information and a unique sequence number which serves as an actual lottery ticket (i.e., without performing an encryption step or forming an information capsule).

### VII. The Draw

1. A random number generator generates a unique random number for every participant's customer profile. Alternatively, a unique number is assigned to each lottery ticket at an earlier time or during an earlier step such as when the image and payment are registered as a lottery ticket.
2. In an intermediate or lottery advancement (or final winner) stage, depending on the number of participants, the random number generator generates one or more numbers.
3. The numbers generated or “drawn” in step 2 are matched to lottery tickets generated or validated in earlier steps by matching such drawn numbers to the numbers assigned or affiliated with such lottery tickets in previous steps. The customers (or customer profiles) associated with such matches are deemed winners (e.g., final or advancement stage winners).
   -or-
4. Steps 2 and 3 can be repeated until the lottery provider (or operator) has a fitting or desired number of participants or images for the final winner draw (e.g., for display on the internet or for broadcast on television or at a spectator event).
5. Optionally, images can be screened by moderators at this stage in addition to or instead of at earlier stages when or if there are large numbers of lottery participants.

### VIII. The Show

1. The television show or webcast or website or stadium display (e.g., at a spectator or similar event) will display images that represent entrants to the lottery.
2. One or more winners will be drawn by a random number generator.
3. The final winner (or intermediate stage winners) will be shown on a television show or webcast or website (or other desired public medium, such as a display screen at a spectator event).
4. If the lottery ticket image was an MMS sent by mobile phone, the participant may be called on the phone number it was sent from, if no preferred alternate number was provided (or may be contacted by other mechanism or means).
5. The show (or webcast or internet display or display at a spectator event) may be broadcast or published as pre-recorded, with delay, or live.

### IX. The Confirmation of Winnings

1. As an optional service, informal confirmation of winnings may be given by SMS, e-mail or MMS.
2. Binding confirmation of winnings is given in writing.

### X. Other Functions and Applications

1. In order to prevent unhealthy and compulsive gambling habits from emerging, a database can be utilized to automatically separate and track the gaming patterns of separate individuals.
   -and/or-
2. If an unhealthy gambling pattern emerges, measures can be taken to prevent negative effects, such as by providing SMS, MMS or email warnings and advice to lottery entrants as well as by instituting restrictions for individual lottery participants. Moreover, restrictions and changes can be made to the lottery game itself. The lottery provider or operator may also, optionally, exclude individuals entirely.
   -and/or-
3. A database or other utility may be utilized, created in association with the operation of the lottery, so that the lottery game automatically enforces age limits or other terms or conditions of the specific lottery game itself (which may be changed from game to game or country to country or state to state, for example).

### Third Example (Non-Limiting) Steps in One Method or System of Administering an Embodiment of the Herein Described Games or Lotteries

In at least one embodiment, there is envisioned a lottery or sweepstakes in which a contestant (or entrant) submits a photograph (or image) to the game provider, in which the game provider generates a lottery number from the photograph submitted. That is, as described elsewhere in the specification, after a photograph is submitted to the game provider, the photograph is analyzed for features such as the number of objects or persons depicted, the shape of the objects or persons depicted, the colors depicted, image contrast, color saturation, etc. As part of this analysis, the data collected is processed and used to generate a unique number from the image, which is thereafter affiliated with the game entrant, and then used as a mechanism to select or drawn a game winner. A description of an example game is provided below:

### Taking the Picture

1. The customer takes a digital picture utilizing a camera-phone or ordinary digital camera.
   -or-
2. The customer scans an ordinary photo or image and uploads the photo or image to his/her phone or computer.
   -or-
3. The customer uses an existing digital image created by the customer or any third party or other source.
   -or-
4. The customer utilizes a publicly available lottery kiosk to create a digital image.

### II. Sending the Digital Image or Picture

1. The digital image is sent to the lottery server by using a mobile phone, tablet, or similar device's MMS utility (or installed software “app” or application).
   -or-
2. The digital image is sent to the lottery server by e-mail or instant message (“IM”) or via an internet chat service or via satellite connection (for instance from a mobile phone or electronic tablet) or by similar electronic mechanism or means (e.g., from a social networking site or web site interface).
   -or-
3. The digital image is sent to the lottery server using a lottery kiosk.

### III. Receiving the Image

1. Subsequent to receipt of an image at the lottery server, the image is analyzed for color, contrast, object numbers/shapes, etc. (as described herein) and the data obtained is used to generate a unique entrant number affiliated with the image and therefore affiliated with the game entrant.

### IV. Sending Receipt (Optional)

1. The customer may be sent a receipt by SMS text to the number registered in the database, and/or the number the image was sent from, as a confirmation of the transaction.
   -or-
2. The customer may be sent an MMS message as a receipt and confirmation of the transaction.
   -and/or-
3. If the image submitted for processing as a lottery entry was deemed unfit for any reason (e.g., unlawful for public broadcast), the customer may be notified by way of SMS or MMS or other mechanism.

### V the Draw

1. A random number generator generates a unique random number to be used as the winning game number.
   -or-
2. A winning number may be selected by other means such as by the game provider selecting or taking a photograph to use to generate a winning number, using the same techniques used to generate the entrant numbers from submitted photographs.

### VI. Winner Selection

1. The number selected as the winning game number in the “draw” step (Step V) is matched to a game entrant number determined in Step III. If no exact match is determined, the closest number to a match is optionally selected. Once a suitable game entrant number match to the winning number is identified, the winner of the game is declared. Such winner is the game entrant that submitted the photograph (or other image) which resulted in the game entrant number which matched (or most closely matched) the selected winning number. Optionally, the image used to generate the winning game entrant number is then identified and used to publicize the winner. Optionally, if no exact number matches are determined in this stage, no winner can be declared and any prizes can be carried over to a subsequent game.

### Alpha-Numeric Lottery Example

Addressing yet additional needs, desires, or drawbacks in the lottery arts (or other drawbacks or needs not specifically described herein), at least one embodiment of the subject invention comprises a unique lottery ticket comprised of digital numbers and/or letters submitted by a contestant in combination with payment for lottery participation. Such a sequence of numbers and/or letters and/or payment information is compiled and/or encrypted to form a secure information capsule which serves as a lottery ticket. When such a capsule is encrypted, the information contained in the lottery ticket (including the identity of the contestant, the numbers and/or letters, and possibly other information) is secured from unauthorized access and therefore aids in preventing tampering with lottery integrity. Because numerous other types of information may be provided in connection with a digital numbers and/or letters (e.g., at the time of purchase of lottery participation), such as a contestant's name, address, phone number, sex, birth date, date/time of ticket purchase, etc., such categories of information, including payment information, are periodically referred to herein as, and are intended within the scope of this document to be, synonymous with the term “contestant information”.

Referring now to FIG. 1, a non-limiting, example embodiment of a lottery system which utilizes such a lottery ticket (e.g., comprised of a digital numbers and/or letters and contestant information compiled or encrypted to form an information capsule) is schematically depicted therein. Generally speaking, such a lottery system 1 includes five main stages or phases which begin with entry of a contestant into the lottery and terminate with the selection of a lottery winner and the broadcast or publication of such lottery winner on a television program, webcast, website, or the like.

More specifically, the lottery begins with phase 1 where the prospective lottery contestant submits digital numbers and/or letters to the lottery provider. Such digital numbers and/or letters may be delivered using a cellular phone (or scanned with a built-in camera) or may be scanned with a conventional camera and then uploaded to a computer or cellular phone for submission. Similarly, a scanner may be used to create a digital numbers and/or letters or an numbers and/or letters may simply be obtained from third party sources or even authored via third party software applications. In still another example, lottery kiosks may be provided in public locations, such as grocery or convenience stores, with such kiosks including scanners and appropriate data or internet connections for submitting numbers and/or letters. Regardless of how the numbers and/or letters are created (and regardless of the type of numbers and/or letters file which is employed), the numbers and/or letters is ultimately submitted to the lottery provider or administrator using suitable methods or mechanisms. These may include, but are not limited to, via MMS message, internet (e.g., via email), proprietary software interface (e.g., contained or downloaded onto a computer, hand held device, or mobile phone), or via the above-described kiosk, for example. In at least one embodiment (not intended to be limiting to the invention), once a numbers and/or letters is submitted to the lottery provider, the numbers and/or letters is stored on one or more lottery servers in association with a unique user profile linked or associated with the lottery contestant (e.g., created simultaneous with, prior to, or after the submission of a suitable numbers and/or letters).

In phase 2, subsequent or simultaneous with phase 1 (or even prior thereto), a lottery contestant submits payment for lottery participation (e.g., payment for entry into the lottery, issuance of the ticket, and the chance at winning prizes or money). Such payment can be completed using functionalities or services offered by contestants' mobile operators where the owners of the mobile phones (or cellular phones) are charged or billed through their mobile subscription either as a credit, debit, or via deduction from a pre-paid account (e.g., a pre-paid SIM card). This billing or debiting (or at least the recording of the transaction) may occur simultaneous with a numbers and/or letters submission to the lottery operator, for example. In other example embodiments, user profiles may be linked to payment services or options such as merchant accounts, credit or debit cards, or PAYPAL type accounts (e.g., such that when an numbers and/or letters is submitted to the lottery administrator, payment is automatically completed via payment services linked to the user profile). However payment is made, in exemplary embodiments of the invention, whenever a numbers and/or letters is submitted to the lottery provider (or when the lottery provider processes or accepts a submitted numbers and/or letters), a valid payment is registered and a lottery ticket purchase (or lottery entry) is fulfilled. Thereafter, in phase 3, the process of creating a numbers and/or letters type lottery ticket is begun.

In particular, during phase 3, the numbers and/or letters file submitted by the lottery contestant is converted into a lottery ticket, as schematically illustrated in FIG. 2, which, optionally, can be used in an existing or conventional lottery process and infrastructure. This conversion, in preferred (but not necessarily all) embodiments, includes a combination or compilation of the digital numbers and/or letters with contestant information, which preferably includes payment information, as defined herein above. Generally speaking, each lottery ticket (e.g., created from a digital numbers and/or letters, etc.) converted or created results in one or two linked self-contained information capsules (e.g., created or stored as a “.lot” file with associated MIME type(s) to process the file), which, in preferred embodiments, carries all (or at least some) information necessary to secure lottery ticket integrity and to re-generate the originally submitted lottery picture or numbers and/or letters (and/or contestant information). Further, in at least some embodiments, each information capsule and lottery ticket (we need one capsule for contestant's information and one for “numbers and/or letters) created will be linked to the users (i.e., numbers and/or letters issuer's or lottery contestant's) unique player profile.

In certain embodiments, when the numbers and/or letters are received from an issuer (i.e., a lottery contestant), the lottery provider or administrator charges a fee to convert the numbers and/or letters into a lottery ticket. In preferred embodiments, traceable banking information—for example routing numbers or information and/or clearing house numbers—will be integrated in whole or in part into the lottery ticket.

Also (in at least some embodiments) during phase 3, to ensure, among other things, that each lottery ticket has a unique value or identifier, a serial number will be generated and integrated into or associated with the lottery ticket. Such a serial number may be generated randomly or as a result of data provided by the lottery contestant (e.g., derived from digital numbers and/or letters information and/or contestant information). There is also a unique serial number generated for every single contestant.

In certain embodiments of the invention (but not necessarily all embodiments), open source extendable numbers and/or letters formats are used for compressing or packing information, but in some cases, non-open source (for example, proprietary) formats will be used. In embodiments in which non-open source or proprietary formats are used, such use may be employed for the purpose of further uniquely identifying numbers and/or letters or generated lottery tickets. Such use, in this regard, may provide security or integrity to the lottery system or method by indicating the presence of or by providing necessary lottery information. Although conventional PKI type encryption may be used to encrypt information capsules and/or tickets and/or contestant information (e.g., so that the tickets or information capsules, etc. can only be opened or accessed by authorized persons to thereby provide additional integrity or security to the lottery system), it is contemplated, of course, that other encryption types or methods may be used (or that other data securitization types or methods, exclusive of encryption, may be used) regardless of whether in existence at the time of the present application for patent.

Of course, each of these steps or processes just described related to encryption, compilation of data, and/or otherwise related to the creation of the information capsule or lottery ticket (whether or not encrypted at this stage or later or not at all) may be performed by the lottery contestant rather than the entity administering the lottery (or such entity's equipment or agent), or by some combination thereof. For example, software may be provided either preloaded into computers or mobile devices or made available as downloads (e.g., as an iPhone software application). Such software could be used by a lottery contestant to pre-encrypt numbers and/or letters and contestant information or to otherwise create a valid, secure lottery ticket (e.g., or information capsule) prior to or simultaneous with submission of such to the entity administering the lottery (whether or not such lottery ticket or information capsule is encrypted, by compiling or combining appropriate data or information).

In phase 4 or the lottery draw phase, a lottery drawing will take place in which lottery entrants will either be selected to advance to intermediate or advancement phases of the lottery and/or a final lottery winner or winners will be selected. In certain example (but non-limiting) embodiments, a lottery draw is conducted utilizing an approved (and preferably secure) random number generator and/or lottery draw machine supplied by one of a number of possible vendors.

In certain but not all embodiments, the draw is completed in several rounds such as “qualification”, “advancement”, and “final” rounds. In an example of one of such embodiments, a first round is completed or performed to select a plurality of lottery tickets which, as winners of an initial lottery stage (or “qualification draw”), enter or proceed to the next levels or stages of the lottery. In such later stages, further draws are completed which select or determine winners to proceed to additional or a final stage(s). As described in more detail below, one or more (or all) of such draws or levels (e.g., including pictures or numbers and/or letters of the contestants advancing) can be broadcast (or integrated into an existing broadcast) on a television program or otherwise publicized such as on a webcast or website. Further, the various levels of draw may be completed or initiated prior to a television broadcast (for example) or, alternatively, as a live component of a television program (e.g., using pre-moderated numbers and/or letters or photographs from or comprising the lottery tickets).

In some embodiments of the inventive lottery methods and/or systems where moderation of numbers and/or letters is employed (e.g., because of local laws regulations or ethical standards), the approval or moderation process is conducted by software. More particularly, such moderators will review and adjudge the submitted, or winning numbers and/or letters to ensure compliance to regulatory and decency issues (i.e., which will typically be different from market to market and from application to application). If a combination of numbers and/or letters is not compliant or is otherwise not acceptable (e.g., as decided by moderators or other mechanism), it can be censored for use in the associated television program or other form of lottery publication or broadcast.

As contemplated by the Applicant herein, at least one purpose of the television broadcast or other type broadcast or publication of the subject lotteries is to provide a more engaging component to the herein described lottery systems and methods. In this regard, by broadcasting or publicizing numbers and/or letters submitted by lottery contestants (see FIG. 3, for example), participation in such lotteries and/or viewership of such lotteries is expected to improve (e.g., because of the prospect of viewing a neighbor's or friend's or one's own, personal submitted numbers and/or letters) thereby bringing additional revenue to such lotteries. Although such goal is believed to be best accomplished by broadcasting or publicizing (visually) multiple levels or stages of the herein described lotteries, it is, of course, contemplated that no stages or only one stage of such lotteries are publicized or broadcast (with the numbers and/or letters information otherwise providing additional verification of the identity of the lottery contestant, among other benefits, for example).

In addition to the other benefits and advantages of the lottery tickets, methods, and systems described herein, it is noted that by utilizing an electronic contestant entry procedure and/or process and/or ticket, in certain embodiments, new lotteries can be organized and/or initiated in short periods of time. Moreover, previously organized or initiated lotteries can be completed in condensed time frames. For example, in certain embodiments, new lotteries can be announced to prospective contestants via television commercials, web broadcasts, SMS texts, or MMS messages, and the lotteries can be completed quickly or within some compressed time frame thereafter. For example, prospective participants generally interested in lotteries could subscribe to notification services which will send SMS or MMS messages (or emails) to such subscribers announcing the creation or initiation of new lotteries. Utilizing the technologies including tickets, methods, and systems described herein, such announced or initiated lotteries could be joined or entered virtually instantaneously (e.g., without requiring a trip to a remote lottery ticket purchase center) such as by return MMS message or email message (e.g., with included numbers and/or letters and/or payment information as described herein above).

Lottery Clearing House and/or Entry Hub

The following is a description of a system or method for preventing the following, negative consequences of gambling, such as: gambling addiction; lack of age control; the player losing his/her ticket; theft of tickets; pollution (paper tickets). In one or more of such embodiments, the player must, before participating in a game of chance, supply two or more of the following: full name; address; phone number; debit card number; credit card number; email address; social security number; date of birth; and/or bank account number. The information is optionally, but preferably, provided by the participant via a mobile phone application or via a website. After the information is sent to the database, it is cross referenced with other sources of information (e.g., driver license information, IP address, encryption token) to ensure that the identity of the participant is correct and that the participant is of legal gambling age. Each participant can preferably only have one player profile. The participant can then, via the participant's credit or debit card, participate in games of chance. Data, such as IP addresses (or similar information), can likewise be used to determine the scope of games which may be legally offered based on detected geographic location.

If the participant wins, the winnings will be transferred directly to the participant's bank account and or credit or debit card. The participant is issued a receipt and the database retains a copy of the receipt or transfers it to a second database. If the participant spends more money than he or she should, the participant will be locked out of the game for a period of time. This will be defined by either the participant's own spending limits or built-in spending limits. The participant can choose to delete or deactivate his/her profile.

In some of the above or other embodiments, there is also provided a unique lottery, in which electronic payment is accepted (e.g., credit card payment). In such a lottery, lottery play is monitored so that frequent players can be identified. If players play too often, they can be warned and/or play suspended for selected times. Frequency of play acceptability can be the same criteria for all players, or based on salary and/or credit history.

In a more specific, alternative embodiment, a gaming entry and/or security hub is provided, the use of which can provide access to a variety of lotteries, sweepstakes, or other games, in diverse locations. For example, in a lottery (or gaming, sweepstakes, or gambling program) deployed for play throughout the United States, a central gaming hub can be maintained which serves as a central entry point and/or clearing house for game entrants, for a plurality of games, located at multiple locations around the United States (or other locations or regions throughout the world, such as within the various member countries of the European Union). Although the term “hub” is used, the meaning of such term is to convey that one or more game contestant registration and/or entry points are provided but where all (or substantially all) registrations or entries pass through a centralized database and/or screening procedure.

By way of more specific example, if a game provider (or developer) within the United States (hereinafter “Game Provider”) wishes to launch a plurality of games accessible to citizens or residents of (or a portion of) the states of the United States of America, the Game Provider will provide or construct a clearing house which includes servers, including computer processors and one or more databases, for intaking contestant information and entries and, through software operations, for processing said contestant information and entries. Of course, the clearing house may also be constructed by third party contractors according to the necessary operational parameters provided by the Game Provider and/or governmental entity. More particularly, as but one example configuration, a Game Provider can provide one or more web portals (e.g., accessible through a uniform resource locator (“URL”) via a web browser connected to the internet) by which a prospective contestant (or game player) can access the hub. If multiple URLs are used to access the webportal, the URLs can be customized to provide information about a specific game in which the prospective contestant has acquired interest. For example, if a “bingo” game and photo-lottery game (as described herein) are both being simultaneously promoted by the Game Provider, an example URL could optionally be selected to be www.gameprovidername_bingo.com for the bingo-style game, and www.gameprovidername_photolotto.com for the photo-lottery style game. Of course, these are examples only, and any unique URL which is available (e.g., not prior reserved or owned by a different entity) can be selected to utilized for access to the hub. The URLs, in turn, will preferably each access the same clearing house (or “hub”) or at least a similar clearing house, which performs the same or similar operations of duplicate (or substantially duplicate), “mirror” hubs. In other words, if multiple clearing house or hub locations (or multiple units of hub-enabling equipment) are utilized, the multiple clearing houses will preferably perform the same entry, registration, and/or screening operations because they each access mirrored (e.g., duplicated) or at least substantially similar databases and contain software with the same or similar operating commands. Accordingly, if different URLs are utilized for different games (such as described in this paragraph), such different URLs can “point” to a specific clearing house provisioned for a specific game (or lottery or sweepstakes) or they can be configured to “point” to the same clearing house which is provisioned to screen and process prospective contestants for both game types. Of course, many additional game types, and therefore many additional URLs can be utilized with the game distribution hub. Conversely, in optional embodiments, a single URL can be used for access by all prospective contestants, for all games. In yet an additional alternative embodiment, the clearing house hub can be provisioned to access outside databases, such as databases maintained by law enforcement agencies, and then to cross-reference information in internal databases (e.g., information collected from prospective game contestants) against information contained in such law enforcement databases, in order to screen prospective game contestants according to criteria described elsewhere herein.

By way of specific prophetic example, a hub can be established by a Game Provider for screening prospective contestants (or game players) and thereafter providing approved contestants with access to games, lotteries, or sweepstakes within the control of the Game Provider. A wide variety of games may be supplied by the Game Provider of course, or the Game Provider may serve as a clearing house only, with third party game providers being provided with electronic access to the hub. A non-limiting list of example games that may be provided by a Game Provider are photo-lottery type games (such as described herein), alpha-numeric lotteries (such as described herein), sweepstakes, and/or bingo-type games.

In order to provide access to the hub, a Game Provider will make one or more URLs available to prospective game contestants, by publicizing the URLs in promotional media, such as online, on television or cable, in print ads, or in messages “pushed” or otherwise delivered to mobile devices, such as mobile phones. In yet another example, a hub URL may be promoted at a live spectator event, for example.

A prospective game contestant, after viewing a Game Provider's promotion(s), can access the Game Provider's hub by accessing it on the internet using a conventional web browser into which the Game Provider's URL is entered. The URL, in turn, accesses a hub portal which is remotely hosted on hub provider servers (or in a cloud based environment). In preferred embodiments, the hub portal includes a user-interface which collects information from the prospective game contestant so that the contestant can be screened for approval for game or lottery play. For example, in one embodiment, a prospective contestant is asked to supply one or a combination of the following: full name; address; phone number; facial (or equivalent) image; debit card number; credit card number; email address; social security number; date of birth; and/or bank account number. The information, input into the Game Provider hub portal (e.g., from a location remote from the portal) is thereafter transmitted via a preferably bi-directional network (e.g., with broadband electronic communication means, such as fiber optics, copper wire, satellite, or wireless networks) to a database associated with the Game Provider hub and at least transiently stored therein. Of course, in certain embodiments, permanent storage is preferred for the purposes of accomplishing better screening, and/or establishment of databases for later screening. In preferred embodiments, the prospective contestant information is thereafter screened, such as by parsing and/or comparing it to data stored in screening databases either maintained by the Game Provider and/or maintained by governmental authorities, such as law enforcement or tax officials. For example, if a facial image is submitted in combination with a phone number, the Game Provider and/or law enforcement database is accessed and the submitted information compared against facial imagery and/or phone numbers in the screening database. Of course, if specialized data—such as a credit card number—is submitted, a third-party database can be accessed or cross-referenced, such as a credit card provider database, to further screen the prospective contestant data. Other examples of specialized data include, but are not limited to, driver license information, IP addresses, and encrypted keys such as may be provided with an encryption token. Screening is envisioned to typically encompass a verification that the prospective contestant is the identity claimed as well as of legal gambling age. Screening can also encompass screening for gambling addiction; overdue taxes; overdue child support or paternity or maternity payments; legal judgments; and/or unpaid or overdue debts. It is also envisioned that the Game Provider can approve or reject prospective game contestants, and/or report contestants in violation of laws (for example) to respective legal authorities. If a prospective game contestant is approved for participation in the Game Provider games, a player profile is therefore established (in this optional embodiment), which the contestant can thereafter utilize to obtain access to available lotteries or games and which the Game Provider can use to monitor the contestant's game play. That is, when a player profile is used to access games or lotteries affiliated with the Game Provider hub, data pertaining to the contestant's game play is stored, such as (for example) money wagered, frequency of game play, and/or amounts of wins and/or losses and/or facial recognition data.

Once the prospective contestant's player profile is screened and approved, a contestant may then use the established player profile, on a repeated basis over time, to access games connected to or affiliated with the hub. For example, while utilizing the Game Provider hub accessed with the provided URL, once the identity of the player is established and the player profile is accessed, various games, and lotteries and/or sweepstakes may be accessed within the same internet portal. This may be accomplished by providing user menus, which list available games for example. Once a game is selected for game play, the contestant is then connected to the game interface which can be delivered and/or stored by the Game Provider's servers (physical or cloud based), or, optionally, third party game providers may link their games to the hub, which also serves as a game distribution or access hub. Of course, third-party games may also be hosted on the Game Provider's servers (physical or cloud) or may optionally be located at third-party locations which deliver the game experience via a bi-directional network.

In one particularly unique (but optional) embodiment, facial recognition technology is used in connection with the hub or clearing house, or similar technologies, to provide additional security-like features. For example, game players (or contestants) utilizing a Game Provider hub (or similar game hub) may have underage children in the household who have access to the game player's computer and discover the game player's credentials for accessing the hub. Alternatively, mobile or computing devices, having access credentials stored thereon, may be lost or stolen. For any of these or similar reasons, if an unauthorized person acquires access to the logon-authentication credentials for the Game Player Hub, or to a device which contains such credentials, there is a risk that an unauthorized person will acquire unauthorized access to the Game Player Hub network (or to the game player or contestant's prizes or funds).

In one optional example embodiment, intended to address the aforementioned (or similar) scenarios, a camera is connected to or integrated with the mobile or electronic computing device. Using such camera (for capturing still images or video), images of the face of a person accessing the Game Player Hub may be compared to one or more (preferably authenticated) facial images (or videos) of the game player associated with the access credentials being contemporaneously used to access the Game Player Hub and/or games accessible thereon. In certain preferred embodiments where authenticated facial images are used as reference images, such authentication may be accomplished using one or more suitable means. For example, drivers license or passport images may be uploaded (or copies thereof physically mailed in) as one mechanism to authenticate true identity. In other optional embodiments, the game player (or contestant) may be required to visit a location where identification (such as drivers license) is checked while images to store as authentication images are captured as still images or video. Camera images taken during game play may then be compared to stored authenticated facial images to prevent unauthorized use of game player access credentials and/or unauthorized access to the Game Player Hub.

Image comparison steps may be performed in different quantities and at different time intervals, depending on the factual situation confronted. For example, it may be desired to only perform facial image authentication steps at initial logon or at “log off”, or the performance of such steps may be reserved for instances in which prizes are to be awarded or are won, or when funds are uploaded or transferred away. In still other option embodiments, facial imagery may be monitored continuously, or alternatively, at time intervals (e.g., every 5 or 15 minutes or other suitable time period). In the most preferred embodiments, computer software stored on Game Player Hub servers contains instructions to automatically perform the facial image authentication steps, without need for any or at least any substantial human intervention.

In similar, but also optional, embodiments, the Game Player Hub may be configured to activate facial image authentication protocols, if unauthorized use of the player profile is detected. For example, if unauthorized use (e.g., a suspicious logon) is detected, the facial recognition technology will execute computer stored instructions and automatically take a photograph (and/or video) of the contemporaneous user and then automatically compare it to stored, authenticated facial images. In this process, the images may also be transiently stored, or permanently stored, or even transmitted as the case may be.

Although various mechanisms for detecting suspicious logons or logon attempts are contemplated, one example is flagging a logon effort as suspicious if access credentials are incorrectly entered one or more times. In other embodiments, the Game Provider Hub collects and/or detects information about each verified game player (or contestant), such as such as an internet protocol (IP) address or MAC address (or other identifier) of the laptop, or other computer, or mobile device used by the prospective game contestant. Patterns of use (e.g., typical time of day and duration of usage, or player habits or personalities) may also be recorded for comparison to future use or patterns. Subsequently, if later logons occur fron non-matching IP or MAC addresses, and/or if logons occur during unexpected times of day (or, for example, during hours where the game player would be expected to be asleep), the facial image authentication protocols described herein may programmed to automatically activate to attempt to verify the identity of the contemporaneous user of the Game Player Hub (i.e., the user which initiated the suspicious logon). Alternatively, authentication protocols may also be activated if unusual or unexpected wagers or game play patterns are detected (e.g., which don't match prior patterns, by being more aggressive, for example). That is, images of the user may be obtained and then compared to stored, authenticated images. And, if images are determined not to match, the suspicious-logon-user may be automatically excluded or terminated from Game Provider Hub access and/or game play. Additionally, the unauthorized user's facial imagery may thereafter be stored to block that user in the future (e.g., if logging onto the hub with other credentials).

If any unauthorized access attempt is detected or determined, facial images captured during the facial image authentication attempt may be stored and/or transmitted to a known or trusted device of the individual associated with the logon credentials in question. For example, a photograph and/or video sequence could be sent by text/MMS message to the trusted cellular device or email of the authorized game player so that the authorized game player is notified of the unauthorized use of the player profile and provided with the photo and/or video to potentially identify the unauthorized user (e.g., if it is their own child). In instances where the unauthorized user is not a family member, for example, such as if the computer/laptop/mobile device has been stolen, the photo and/or video of the unauthorized user can be provided to law enforcement to identify, and prosecute if appropriate, the unauthorized user.

Game contestants can use credit cards, in some embodiments, to pay for game play. In other embodiments, payment made be made via wire, electronic bank transfer, electronic check, payment providers such as a Paypal, Zell, or Venmo, or via digital currency (e.g., Bitcoin). In alternative embodiments, unique methods of payment for play may be utilized. For example, a game contestant may be required to purchase a physical game or lottery ticket with cash. The physical ticket can include a code covered by a scratch off film, which the game contestant removes (e.g., using a coin or finger nail or similar method) to reveal the code. The code can then be supplied to the Game Provider hub, which is then cross-checked against a database. In other words, the entry of the code confirms to the Game Provider that the game play has been paid for with cash, and the Game Provider can thereafter be compensated by the ticket seller (who received the cash payment) such as through electronic transfer of funds. The ticket seller, in such instance, preferably retains a portion of the ticket sales price as a commission to compensate the ticket seller for the effort involved in processing and enabling the transaction. In such a method, a convenience store may sell a scratch-off ticket in a state such as Arizona (for example) to a prospective game contestant. The code is then revealed by scratching off the scratch-off film and thereafter used to prove payment for game play by entering the code into a web interface of a mobile device (or other web or network accessible device) which, in turn, accesses a Game Provider's clearing house hub in a far away locale, such as Florida (for example). Verification of the code authenticity and value amount can be obtained by accessing an additional database (such as a banking or governmental lottery database) or via parsing data stored on the Game Provider's database (on physical servers or in a cloud).

If a game participant wins during game play, the winnings may be recorded to maintain a credit balance, or, optionally, will be transferred directly to the participant's bank account and or credit or debit card (or other payment receipt location or as digital currency). The participant is preferably issued an electronic receipt and the database retains a copy of the receipt or transfers it to a second database. In certain optional embodiments, if the participant spends more money than he or she should, or if it is determined that the player has debts elsewhere (e.g., late child support payments), the participant will be locked out of the game for a period of time or input or won funds may be transferred to a third party or to a governmental entity, such as a legal authority. Of course, game providers or legal authorities can define spending or game play limits, which may vary by state law. As a unique benefit, since different states may have different state laws pertaining to game play, spending or game play limits may therefore be set differently for each game player (i.e., contestant) based on their detected physical location or detected place of citizenship or residency. In other words, game play and spending limits (and other parameters) may be tailored for specific players, with different players supplied with different spending (or game play) limits, even though such different players are accessing a single Game Provider clearing house hub.

### Example (Non-Limiting) Steps in One Method or System of Administering an Embodiment of the Alternative Embodiments of Games/Lotteries

### I. Registering the Customer

1. In certain embodiments, for a customer to enter the lottery, the customer must provide or register one or more of the following details:
   Name
   Phone number
   E-mail
   Address
   Birth date or age
   Bank account
   Social security number
2. Terms of use are presented or displayed and may be required to be accepted by the customer prior to issuance or acceptance of lottery ticket.
3. Information registered in the database may be encrypted.

### II. Creating the Ticket

1. The customer creates a sequence of numbers and/or letters using a mobile phone, tablet or PC. These numbers and/or letters are the customers potential winning numbers and/or letters.
   -or-
2. The customer scans a note with printed numbers and/or letters and uploads the numbers and/or letters to his/her phone or computer.
   -or-
3. The customer uses existing digital numbers and/or letters created by the customer or any third party or other source.
   -or-
4. The customer utilizes a publicly available lottery kiosk to create digital numbers and/or letters.
   III. Sending the Numbers and/or Letters
1. The digital numbers and/or letters is sent to the lottery server by using a mobile phone application utility or web interface.
   -or-
2. The digital numbers and/or letters is sent to the lottery server by e-mail.
   -or-
3. The digital numbers and/or letters is sent to the lottery server using a lottery kiosk.

### IV. Paying

1. The customer pays in advance by way of an existing, conventional payment and debit solution for mobile phones.
   -or-
2. The customer has the cost of the lottery ticket (e.g., and possibly the cost of the data transfer) deducted from his or her pre-paid mobile phone card (e.g., instantly).
   -or-
3. The customer pays via the internet by way of bank transfer.
   -or-
4. The customer pays via the internet by way of debit card or credit card.

### V. Receiving Payment

1. When payment is received by way of an existing payment and debit solution for mobile phones, the payment and its amount is encrypted, registered and linked to the customer's profile in the database.
   -or-
2. When payment is received or confirmed by the customer's mobile phone carrier by way of deduction from the customers pre-paid mobile phone card, the payment and its amount is registered and linked to the customer's profile in the database.
   -or-
3. When payment via internet is confirmed by a credible or trusted third party (i.e., a bank, credit card merchant, PAYPAL, etc.), the payment is registered and linked to the customer's profile in the data base.
   VI. Receiving the Numbers and/or Letters
1. Upon receipt of an numbers and/or letters at the lottery server (or at a later time prior to broadcast or publication, for example), the numbers and/or letters may be manually checked in order to make sure it complies with laws and/or general ethical standards.
2. If an numbers and/or letters is, for some reason, not in compliance with current laws or ethical standards (e.g., because it is obscene, insulting in nature, etc.), the numbers and/or letters may be replaced with a standard, computer generated numbers and/or letters.

### VII. Sending Receipt

1. The customer will be sent a receipt by SMS text to the number registered in the database, and/or the number the numbers and/or letters was sent from, as a confirmation of the transaction.
   -or-
2. The customer will be sent an MMS message as a receipt and confirmation of the transaction.
   -and/or-
3. If the numbers and/or letters submitted for processing as a lottery entry was deemed unfit for any reason (e.g., unlawful for public broadcast), the customer will be notified by way of SMS or MMS or other mechanism.
4. and/or the customer is notified via the customers player profile online
5. and/or the customer is notified via a designated mobile phone and/or tablet app

### VIII. Registering and Creating the Lottery Ticket

1. Upon receipt of the numbers and/or letters at the lottery server (or, in other embodiments, prior to submitting the numbers and/or letters to the lottery administrator), the numbers and/or letters may be encrypted.
2. The encrypted numbers and/or letters is linked to the payment, the amount and origin of the payment (and possibly other contestant information, if desired) and may be assigned and linked to a unique sequence number. The encrypted numbers and/or letters serves as the actual lottery ticket.
3. The lottery ticket created in step 2 above is linked to the customer's profile.
   -or-
4. The received numbers and/or letters is combined with contestant information, payment details, and a unique sequence number and is encrypted to form an information capsule which serves as an actual lottery ticket.
   Ix. The Draw
1. A random number generator generates a unique random number for every participant's customer profile. Alternatively, a unique number is assigned to each lottery ticket at an earlier time or during an earlier step such as when the numbers and/or letters and payment are registered as a lottery ticket.
2. In an intermediate or lottery advancement (or final winner) stage, depending on the number of participants, the random number generator generates one or more numbers.
3. The numbers generated or “drawn” in step 2 are matched to lottery tickets generated or validated in earlier steps by matching such drawn numbers to the numbers assigned or affiliated with such lottery tickets in previous steps. The customers (or customer profiles) associated with such matches are deemed winners (e.g., final or advancement stage winners).
   -or-
4. Steps 2 and 3 can be repeated until the lottery provider (or operator) has a fitting or desired number of participants or numbers and/or letters for the final winner draw (e.g., for display on the internet or for broadcast on television).
5. Optionally, numbers and/or letters can be screened by moderators at this stage in addition to or instead of at earlier stages when or if there are large numbers of lottery participants.

### X. The Show

1. The television show or webcast or website will display numbers and/or letters that represent potential winners of the lottery.
2. Winning numbers will be drawn by a random number generator.
3. The winning numbers and/or letters will be shown on a television show or webcast or website (or other desired public medium).
4. If the lottery ticket numbers and/or letters was sent by mobile phone, the participant can be called on the phone number it was sent from, if no preferred alternate number was provided.
5. The show (or webcast or internet display) may be broadcast or published as pre-recorded, with delay, or live.

### XI. The Confirmation of Winnings

1. As an optional service, informal confirmation of winnings may be given by SMS, e-mail or MMS.
2. Binding confirmation of winnings is given in writing.

### XII. Other Functions and Applications

1. In order to prevent unhealthy and compulsive gambling habits from emerging, a database can be utilized to automatically separate and track the gaming patterns of separate individuals.
   -and/or-
2. If an unhealthy gambling pattern emerges, measures can be taken to prevent negative effects, such as by providing SMS, MMS or email warnings and advice to lottery entrants as well as by instituting restrictions for individual lottery participants. Moreover, restrictions and changes can be made to the lottery game itself. The lottery provider or operator may also, optionally, exclude individuals entirely.
   -and/or-
3. A database or other utility may be utilized, created in association with the operation of the lottery, so that the lottery game automatically enforces age limits or other terms or conditions of the specific lottery game itself (which may be changed from game to game or country to country or state to state, for example). For example, the details submitted by the lottery entrant in Step I (“Registering the Customer”) maybe transmitted to or checked against a database and/or cross-referenced with data sources to verify the identity of the player and/or the age of the player and/or the playing habits of the player.

Although various embodiments of lotteries (or sweepstakes or other games) are described herein which involve photographs or video footage as entry tickets, social media entry pathways, alpha-numeric entry and selection phases, among others, additional embodiments which combine such lottery types and games are contemplated. For example, in embodiments in which photographs or video footage is/are submitted as a lottery entry, the winner selection phase (e.g., where a photograph entry is selected as a winner) may be preceded by an alpha-type (or alpha-numeric) lottery. By way of further explanation of one such example contemplated, the first phase of an envisioned lottery may include a word or sentence matching stage which must be successfully completed to compete in the photograph (or video) entry phase. By combining such embodiments, the technological benefits of both may be realized. For example, the ease of deployment and certainty in winner selection may be obtained with the photo-entry portion of the lottery with the addition of alphabet characters to the lottery adding complexity to that portion of the drawing phase (to assist in minimizing or preventing duplicate winners). Additionally, utilizing such a hybrid lottery, additional revenue can be realized by including the additional play stage. For example, increased revenue may be generated by utilizing a per-letter entry fee structure for a dual-stage lottery (as compared to a single stage lottery) where the second and winning stage of the lottery is determined by selecting the photograph (or video footage) of the lottery (or sweepstakes) winner.

Location Based Game Play Opportunities and Virtual Travel Game Play

In addition to the myriad inventions described above, Applicant has also conceived of unique apparatus, systems, and methods which embody, generate, synthesize, and/or deliver hybridized real/virtual world experiences in real/virtual hybridized worlds. For the purposes of discussing the inventions detailed below, real/virtual hybridized worlds—formed by combining imagery and/or experiences from both the real world and a software generated virtual world—are hereinafter referred to as “synthesized worlds” (or the “synthesized world”). This term is used by Applicant regardless of whether the “synthesized world” is primarily composed of virtual content or primarily composed of real world content (or contains co-equal content, or any other mixture of any proportion).

In preferred embodiments of these numerous inventions, the real/virtual hybridized worlds include games located at specific geographic locations in the synthesized world(s). These geographic locations, at which such games are found, are “physical” locations in the synthesized world which, in preferred embodiments, are associated with real geographic locations in the real world.

By way of more specific example, a mobile computing device is provided which includes one or more computer processors, a a data storage mechanism (e.g., a hard drive or flash drive or similar storage technology), a camera, and a user viewable screen. The mobile computing device also preferably includes network connectivity capabilities, such as a wireless antenna and network card for connecting to a wireless internet network, such as delivered over a conventional wireless local area network (“WLAN”) or satellite (e.g., as a cellular signal). The mobile computing device also (preferably) includes means for automatically and autonomously detecting the geographic coordinates of the device, including the real world physical location of the device as well as any travel to different real world geographic locations. Such means for detecting geographic coordinates can include a global positioning system (“GPS”) (e.g., built into the device) or cell tower triangulation techniques or any other mechanism or method for detecting the real world location of the device as well as any travel therethrough. In certain embodiments, location data may also be derived from sources such as IP addresses.

In addition to the above features, the mobile computing device also includes software stored on a data storage mechanism, or accessed by the device using network connectivity (e.g., such as connectivity to a cloud based network), which is provisioned to execute computer implemented instructions pertaining to the functionality of the herein described inventions. For example, in one exemplar embodiment, a human user of the mobile computing device activates the device and, using a graphical user interface (e.g., optionally operated by a touch screen), instructs the device to open a software program (e.g., stored locally or in a cloud network) which enters the human user into the synthesized worlds of the inventions described herein. Upon beginning the program for the first time, the human user is preferably asked to create a character for game play or, in the alternative, a stored player profile is used to begin the game. Regardless, a “player character” is selected (or assigned) and used in the game, and the character is depicted in the synthesized world of the game at a physical location corresponding to the detected location of the human user carrying the mobile computing device. In other words, the mobile computing device, using GPS or similar location detection technology, detects the real world location of the human user (which corresponds to the location of the mobile computing device) and then places the “player character” in that same physical location within the game.

Of course, the player character may be displayed on the user viewable screen as if viewed by a third person (in a third person view), or a point-of-view (“POV”) perspective may be displayed on the user viewable screen (e.g., a view as if seen through the eyes of the player character). Moreover, the physical location in the game where the player character is placed and graphically depicted may be a live view of the real world as captured by a camera located onboard of the mobile computing device. Alternatively, the physical location may be depicted as a non-live view of the same geographic location which is synthesized using stored images (or video) of the geographic location. Still further alternatively, the physical location may be graphically rendered by software to resemble the appearance of the geographic location (e.g., based on stored data pertaining to the geographic location), whether in photo-realistic or cartoon-like (i.e., non-photo-realistic) fashion (or any combination thereof). Regardless, in preferred embodiments, the system—at least in some stages of the game—displays a graphical representation of the detected physical location which shares physical aspects or attributes of the real world location, to lend feelings of authenticity to the experience of the human user. For example, if the game is initiated while the human user is located near a known landmark—such as the Washington Monument—the player character will be displayed near the Washington Monument on the user viewable screen, or the Washington Monument will be visible in the alternative POV-type view. Further, the world view depicted on user viewable screen will change (or move or rotate) depending on the direction the player character is facing in the game. For example, in preferred embodiments, the direction the player character is facing can be selected or changed by the human user, and the synthesized world view depicted on the user viewable screen will change accordingly (e.g., to reflect what might be visible through the eyes of the player character when a POV-type view is utilized). Of course, a provider of the game (or software therefor) can determine which geographic features appear in the game and which do not. In the example described above, for example, one game provider may elect to include a depiction of the Washington Monument, whereas another game provider may elect to exclude the monument (but while possibly displaying the park-like areas surrounding the monument by themselves instead). In still other embodiments, the monument may be displayed but may be modified or customized in some fashion according to the desire of the game provider.

Once the human user initiates the game, and once the player character is rendered in the view of the real world (whether live or software generated) on a user viewable screen, the player character moves throughout the synthetized world of the game as the human user moves in the real world. More specifically, once the game is initiated, a location detection mechanism on the mobile computing device is automatically software activated. In preferred embodiments, the location detection mechanism is a global positioning system (“GPS”) device (or device with similar functionality) which (preferably) continuously monitors the real world geographic position of the mobile computing device. Therefore, in the example described above, if a human user begins a real world excursion at the Washington Monument (in Washington, D.C.) and then walks to one of the Smithsonian museums, the player character will also be depicted, on the user viewable screen, as traveling to the selected Smithsonian museum, at the same general pace as the human user and passing the same interim geographic locations as the human user. This is accomplished, in this example embodiment, by processing the GPS geo-location data which is obtained, processed, and recorded as the location detection mechanism detects the location of the human user by continuously detecting and therefore monitoring the location of the mobile computing device (carried by the human user).

Various options are contemplated for depicting the travels of the player character as the human user of the mobile computing device travels among various locations in the real world. In preferred (but non-limiting) example embodiments, however, the world depicted is a synthesized world comprised of imagery representing the real world location of the human user, combined with virtual world imagery (or characters) which is rendered from data fed to the mobile computing device and processed by its processors. Accordingly, the synthesized view which is displayed on the user viewable screen will, at select times (but not necessarily always), be a combination of real and virtual world features.

By way of further example, in order to reward a human user for traveling to a Smithsonian museum (or other selected geographic location or landmark), an administrator of the herein-described systems can feed data to the network (e.g., pre-stored on a remote database) which renders a game near a location of the Smithsonian museum, which can be played by the human user, using the player character in the synthesized world as a proxy. More specifically, once the human user arrives at or proximal to a selected geographic location—deemed a game-location-target—such as the Smithsonian Air and Space Museum, the user's arrival is detected by the location detection mechanism (e.g., GPS) of the mobile computing device. Because the mobile computing device regularly (e.g., preferably continuously) checks detected real world location coordinates against a database of stored game-location-targets, the mobile computing device “knows” when a game-location-target has been reached e.g. when real world location coordinates and game-location-target coordinates match. Once an arrival at a game-location-target is detected, an opportunity to play a game—such as a lottery, sweepstakes, game of skill, or game of chance—is offered to the human user via the player character acting in proxy. The offer of the game, in preferred embodiments, is made by augmenting the depiction of the real world on the user viewable screen with additional graphical data or imagery. For example, a lottery kiosk may be virtually rendered (e.g., from stored data) such that it appears, in the synthesized world, as if it is located at or near the entrance of the Air and Space Museum. In another example, a blackjack gambling table could be rendered and depicted in the Air and Space Museum atrium (i.e., in the synthesized world depicted on the user viewable screen). In either event, the player character in these embodiments is then permitted to play the lottery or blackjack (or other game) offered, with the human user controlling the actions of the player character.

In alternative embodiments, when or if it is desired to refrain from displaying the offered game within the synthesized world imagery itself, once a game-location-target is reached, the user viewable screen can terminate display of the synthesized world and begin a display only of the offered game. In still further alternative embodiments, when a player character arrives at a game-location-target (because the human user has travelled there with the mobile computing device), instead of offering a game for immediate play, a right-to-play can be awarded to the player character (or its corresponding human user) so that a game can be played at a later time, when it is more convenient or appropriate or safe. In other words, upon reaching a game-location-target, a right-to-play is recorded as data associated with the human user (or his/her player character), which effectively serves as a ticket which can be redeemed for later game play. Of course, in some embodiments, it may be required to manually redeem the ticket, but in other embodiments the existence of the ticket can be automatically and autonomously detected (e.g., game play is permitted without requiring additional steps to prove existence of the right-to-play). Accordingly, in the embodiments in which right-to-play opportunities are recorded, if the human user earns the right-to-play because of his/her visit to the Air and Space Smithsonian Museum (or other selected location), the human user can wait until he/she arrives at home (or other location) to play the game offered as a result of finding the game-location-target.

In some embodiments of the systems and apparatus described herein, game-location-targets can be selected, created, and/or stored in a database—accessible to the mobile computing device—by an administrator of the systems and games described herein. Further, the games made available when a game-location-target is visited by a human user (and/or player character associated therewith) may also be selected, created, and/or stored for access in a database by a system administrator. However, in alternative embodiments, the game-location-targets—and/or the games themselves—can also be selected, created, and/or uploaded to a user accessible database by third parties. In such an embodiment, a data insertion portal may be provided to third parties so that such entities can self-upload either the game-location-targets, the games, or both. In yet an additional variant embodiment, both the system administrator and third parties both select, create, store, and/or upload game-location-targets and/or games for discovery and play by player characters (as proxy for their human users).

In another similar embodiment, third parties are required to pay the system administrator (or its owner, etc.) for rights to upload game-location-targets and/or games. By way of further explanation, third parties can have reasons to attract human users to geographic locations. For example, a store owner may wish to direct walking traffic to a new store location. Having such goal in mind, a store owner, upon payment of required compensation to the system administrator, can provide or upload game-location-targets into the system, such as a game-location-target in the vicinity of the new store location. Further, data for rendering map points or location clues can be supplied to the administrator or self-uploaded by the store owning third party. For example, maps or clues may be rendered graphically by software in the synthesized world(s) so that a player character encounters them and is ultimately directed to a desired game-location-target.

In yet another example embodiment, the system is designed with a goal of motivating human users to exercise. In at least one such embodiment, the mobile computing device includes a travel detecting mechanism which detects when the mobile computing device is physically travelling (because its human carrier is traveling) while also determining and recording (as data) the distance of physical travel. Further, after the human user is determined to have travelled in excess of a selected-target-travel-distance, a game is made accessible to a user of the mobile computing device. Having the goal of motivating human exercise, coordinates for game-location-targets can be selected by a game administrator or third party game provider which are sufficiently distant from the detected geographic location of a human user to ensure that the human user is required to travel a sufficient distance, which corresponds to a beneficial amount of human exercise, in order to be granted permission to play a game available at the game-location-target(s).

In these (and possible other) embodiments, it is of course desirable to know whether the human user is actually walking when traveling with the mobile computing device, as opposed to driving (or riding in a car) or taking some other form of motorized transportation. Accordingly, the system—in this embodiment (or similar embodiments)—preferably includes a mechanism for detecting whether the movement of a human user (carrying the mobile computing device) is walking-movement vs. machine-assisted-movement. In one iteration of such an embodiment, the speed of travel of the mobile computing device can be determined by measuring the distance traveled in a given time, and then mathematically dividing the distance value by the time value. For example, because the mobile computing device is (preferably) continuously monitoring the physical location of the device, the distances travelled for a given time period can also be calculated, and then a rate of travel determined. Then, because it is known that the typical walking speed is approximately 2 to 4 miles per hour, and maximum walking speed is approximately 5.6 mile per hour, if the rate of travel (of the mobile computing device) is detected to be in excess of—for example—8 miles per hour, one embodiment of the systems described herein will conclude that the human user is no longer walking. Accordingly, in some optional embodiments, any distances travelled at speeds in excess of 8 miles per hour (or another speed selected by the administrator as the maximum plausible human walking speed) will not be tallied in the process of determining whether a human user has travelled in excess of a selected-target-distance.

In the same or similar embodiments, it is of course contemplated that a human user may use various forms of travel, during a given period of use of the mobile computing device, to explore the synthesized worlds described herein. Accordingly, in certain embodiments, the mobile computing device will tally both machine locomotion (e.g., travel by vehicle, such as when velocities are determined to be above 15 miles per hour) and human locomotion, but will only count human locomotion against travel required to meet any selected-target-distance. In still other embodiments, however, the system may be instructed (e.g., through modified software instructions) to accept or count machine locomotion when determining whether collective distances travelled are in excess of a given selected-target-distance. For example, it is generally recognized that some cities or neighborhoods are more easily travelled by walking than others. For example, a city neighborhood—such as Georgetown in Washington, D.C.—has numerous sidewalks and walking paths, and numerous locations to explore when traveling by foot. Such a neighborhood is deemed to have a high-walkability score. Conversely, some cities or neighborhoods have few sidewalks or paths, or few stores or other attractions to explore, and are therefore thought to have low-walkability scores or values. Recognizing this, in certain embodiments, the system may be instructed (through modified software instructions) to permit more machine-locomotion travel to count against meeting a selected-target-distance threshold of travel, if the mobile computing device is detected to be in a low-walkability locale. Likewise, if a city has a high-walkability score, lower (or no) machine-locomotion travel may be counted (while the mobile computing device is detected to be in such low-walkability locale). Still further, as the human user travels with the mobile computing device, if the user travels between or through both high and low-walkability locales in one or more trips, the mobile computing device can automatically and autonomously adjust and tailor the percentage of machine-locomotion travel (from 0 to 100 percent) that will be counted against a given selected-target-distance (in certain preferred embodiments). That is, the system can automatically calculate and adjust walkability data based on information available or provided in connected databases. Alternatively, for embodiments where the primary goal is to drive human traffic to specific locations, regardless of the method of locomotion, method or speed of travel can be ignored entirely.

Alternatively, instead of using selected-target-distances, such as for setting threshold walking locomotion distances that must be met or exceeded, an administrator may set target-machine-locomotion-travel-distances instead (e.g., where all machine-locomotion counts towards meeting travel thresholds), such as in embodiments where the purpose is to encourage travel rather than merely exercise (such as walking exercise). Of course, in embodiments where encouraging or motivating exercise is a goal, if no walking-locomotion is detected, no game will be offered to the human user (or his/her player character). Similarly, if a human user is detected to change from walking speed to machine-locomotion speeds (or simply if no walking-locomotion is detected), the mobile computing device can display a message visible on the user viewable screen, advising that no current travel (e.g., because it is not walking travel) is being counted towards meeting distances-traveled goals. In still other embodiments, it is contemplated that the mobile computing device will self-disable, or the display of the synthesized world(s) will be paused or disabled, if machine-locomotion is detected. This may be for safety among other reasons (e.g., to prevent a human user from driving while operating the device).

In still other alternative embodiments, if a game-location-target is placed (such as by a game administrator or third party), and if the human user of a mobile computing device is volitionally traveling to the game-location-target, the target can be de-activated if machine locomotion is detected. Or, in embodiments in which some machine locomotion is permitted, then target may be deactivated only if the ratio of machine assisted locomotion-to-walking locomotion does not exceed a determined acceptable ratio, which is chosen to promote human exercise. In still other embodiments, if machine locomotion is detected in excess of permissible machine locomotion, the game-location-target may be moved to a more distant location relative to the location of the human user. This movement of the game-location-target is accomplished, in some preferred embodiments, automatically and autonomously by the system according to computer executable instructions supplied to a processor.

Although certain entities and organizations publish walkability scores and definitions for cities or towns or neighborhoods, these definitions are not intended to be limiting to the scope of this application. That is, Applicant can calculate and/or provide values for “walkability” associated with a particular locale (either high or low) how it chooses according to the criteria it chooses. Alternatively, for efficiency, known third-party walkability-scores may be implemented into the system. In either event, in embodiments which utilize walkability data, the data is accessed as needed for implementing the embodiments described herein.

In at least one embodiment where synthesized worlds are offered for virtual travel and game play, the synthesized worlds can be delivered via a game network access granting hub as discussed elsewhere within this specification. Of course, the synthesized worlds can also be provided and/or delivered independently, as a stand-alone product. However, in at least one embodiment in which a game network access granting hub serves as a world's entry portal, a prospective visitor/traveler of the world(s) electronically submits applicant access credentials comprising identifying information to said game network access granting hub, accompanied by a request for access. Once the credentials and request for access are received, the game network access granting hub performs steps to verify the true identity of prospective visitor/traveler and preferably screens the prospective user for criteria to permit or deny them entry into the synthesized world(s). Of course, once access is granted to the synthesized worlds, access may also be permitted to other games provided by the game provider or third-parties.

In certain exemplary (but still non-limiting) embodiments utilizing synthesized worlds, the real world location of the user/traveler is detected to determine which laws pertaining to gaming and the like are applicable to the user/traveler at the specific detected location. For example, a game such as black jack may be legal in Nevada but illegal in California. Accordingly, in some embodiments, once the real world location of the user/traveler is detected, a database is parsed to determine which games are legal in the specific detected locale, and then only legal games are offered for play to the user/traveler.

In another embodiment envisioned by Applicant, travel through a synthesized world may occur even though the human user/traveler is not traveling geographically in the real world his/herself. That is, for example, a character representing the human user/traveler can be caused to travel in a synthesized world using software or hardware controls, while also being provided with the opportunity to visit virtual game-location-targets and to play games at such targets. In such embodiments, it is preferred though not required that the geographic location of the human user/traveler be detected and that only games which are legal in the real world location of the user/traveler are offered for participation or play, regardless of the location of the virtual character traveling through the synthesized world. In still other embodiments, such as these in which travel to simulations of real-world locations happens only in the virtual world(s), options for virtually visiting stores and other business may likewise be provided.

As discussed herein above, synthesized worlds through which user/travelers travel are preferably comprised of visual imagery corresponding to both the real world and an imaginary or synthetic world, envisioned by and programmed by a software programmer. In such a synthesized world, real world imagery can be supplied from a database comprised of imagery collected in the past which depicts the geographic location. Accordingly, as the user/traveler is traveling, and the location of the user/traveler is detected, a database (in some embodiments) is parsed for imagery associated with the detected geographic location or coordinates. Thereafter, once the imagery is identified, it can be used to synthesize a hybrid real/virtual world, which includes real world imagery, even without use or availability of a camera (e.g., on the mobile computing device). The system, moreover, can accurately determine which imagery to display—based on the direction the character of the user/traveler is facing (or the direction the human user is facing)—using gyroscopes or accelerometers or similar technology integrated within the mobile computing device which is processing the game/world software instructions. While such an embodiment is beneficial because no camera is needed onboard the mobile computing device (or none need be operated), such an embodiment also uses substantial computer processing power and network bandwidth if accessing pre-stored imagery located at a remote location. Accordingly, another alternative embodiment is envisioned where a camera is used to provide a live video feed of the real-world portions of the synthesized world on a display for viewing by the human user. Using such a live video feed of the actual geographic location of the user/traveler, it becomes unnecessary to locate location specific imagery (e.g., on a remote database) and to process such imagery to create a real-world location view. Consequently, processing power and battery power (if batteries are being used) is saved, and video display lag time is reduced. Of course, even if live video is collected from a live video feed, it is possible to process the video to enhance it with additional imagery and/or to provide it with a non-photorealistic appearance. In these embodiments, while it is envisioned that a camera onboard the mobile computing device would be used, it is also envisioned that an external camera can be used, such as mounted on the chest or head of the human user/traveler e.g., connected to the mobile device with hard wires or Bluetooth or any other suitable data communication technology.

In some embodiments, it is envisioned that games offered for play at game-location targets will be offered for free game play. In other embodiments, game play may require payment and/or may require monetary wagering. For example, if a lottery ticket is offered at a game-location-target, a fee may be charged for the lottery ticket. Similarly, if a black jack table is offered (in a synthesized world) at a game-location-target, wagering may either be with fictional or real money (offering fictional or real money or prizes for winning). Payment for game play or wagering may be made, in these embodiments, using accounts affiliated with the user/traveler account. For example, if the user/traveler has an established account with the embodiments utilizing a hub clearing house, the monetary funds in that account can be used for game play. Alternatively, money can be transferred into an account for game play using wire transfers, credit cards, cryptocurrency, or similar technology. In yet further alternative embodiments, when a game-location-target is visited in a virtual (synthesized) world because the user/traveler has traveled to a corresponding real world location in the real world, the human user may be prompted to proffer payment for game play or wagering at that time. Such payment can be made in various ways, For example, a credit card payment or wire transfer can be made at that time. Similarly, a third-party payment system such as Paypal or Venmo can be prompted to send the user/traveler a payment invitation. A payment opportunity such as Apple Pay (or other digital wallets) could also be used.

In embodiments in which third-parties have placed (or paid for placement of) game-location-targets at or near their brick-and-mortar locations to entice human traffic to their real world physical locations, in person payment options may also be provided. By way of illustrative example, if a third party coffee shop owner places (or pays for placement of) a game-location-target at or near their coffee shop (with hopes of boosting business of the coffee shop), the coffee shop owner can require payment for game play at the real world cash register (or similar payment acceptance location) of the coffee shop. In such an example a code, such as a QR code or alpha-numeric code, can be generated upon payment and then scanned by the mobile computing device of the user/traveler (or vice versa) to notify the system that game payment (or wagering funds) have been received. As another example, a payment code may be generated on a payment receipt or a scratch-off ticket may be sold which include a scratch off film which must be removed to reveal a code.

Alternatively, instead of requiring direct payment for game play, game play can be unlocked upon purchase of at least a minimum monetary amount of services. For example, if the minimum purchase is selected to be $10, if the human user purchases more than ten dollars worth of coffee and/or food or other products from the coffee shop, a code can be generated to unlock game play (other mechanism or instructions for unlocking game play may also be used in lieu of codes such as QR codes). Of course, even though it is envisioned that payment is required in some embodiments, in other embodiments, game play may be offered for free. For example, when the user/traveler is detected to be at a real world location which corresponds to a game-location-target, the software may be provisioned to automatically unlock game play. In such embodiments, although not required, the third party itself may pay for or fund the game play such as by paying the synthesized world administrator for rights to place a game-location-target at or near their place of business. In still other envisioned embodiments, arriving at the game-location-target may not be enough, even for the embodiments where game play is free. For example, free game play may also require a code to be scanned or entered, and such a code may be hidden within a place of business so that the human traveler must enter the place of business to locate and scan (or enter the code). Using the coffee shop example again for illustration, a QR code may be printed on an in store menu which the human user must scan with mobile computing device in order to unlock game play.

In yet still other embodiments, a third party may—instead of placing a game-location-target at a place of business—place a game-location-target at a non-business place of interest such as at a scenic overlook, a distinctive tree, a beach, or at an artwork display (all being non-limiting illustrative examples). Then, instead of requiring an in-person business visit for game play, the user/traveler may be shown sponsorship information or an advertisement of some variety so that the third party gains value for sponsoring the game-location-target (even though the target is not located at the third-parties place of business). Similarly, governments or non-profits seeking to encourage outdoor exercise or appreciation of nature or the arts (or similar non-profit related goals) can sponsor and place game-location-targets such as at state or national parks or museums and the like.

In addition to the above-embodiments, non-commercial embodiments may be offered such as for use by friend networks or families. For example, if a parent wishes for their child to experience more of the outdoors and nature, a parent can place game-location-targets at locations such as the beach or public parks. Of course, in such embodiments, the games which are offered to reward the child are unlikely to be of the gambling variety, and educational or simply entertaining games may be provided and unlocked for game play. Similarly, it is envisioned that a network of a group of friends can create group treasure hunts by placing game-location-targets within the synthesized worlds discussed herein.

While the majority of embodiments discussed herein relate primarily to synthesized worlds comprised of a combination of real world and virtual world imagery hybridized to result in a synthesized world, embodiments are envisioned which minimize or eliminate real world imagery altogether but which still log travel in the virtual world by tracking real world travel in the real world. Further, while the majority of the discussion herein relates to a single user/traveler through one or more synthesized worlds, various embodiments are envisioned where multiple human users can deploy multiple user/travelers within the same synthesized world(s) and where the multiple user/travelers can interact with one another, exchange gifts or things of value (e.g., money or cryptocurrency), or play games with one another or participate in the same game play (e.g., such as by sitting at the same black jack table, playing black jack simultaneously with other user/travelers).

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined.

What is claimed is:

1. A game network comprising data transmission equipment, at least one game network data processor, and at least one game network data storage device;
said game network including hardware and/or software particularly configured to control said game network such that it operates to provide a game network access granting hub on which the following method steps are performed:
an applicant-game-contestant electronically submitting applicant access credentials comprising identifying information to said game network access granting hub, accompanied by a request for access to a network of a plurality of games which are selectively accessible to applicant-game-contestants which have been approved for access to said game network access granting hub;
said game network access granting hub receiving said applicant access credentials, processing said applicant access credentials, performing steps to verify a true identity of said applicant-game-contestant, and screening said applicant-game-contestant for criteria to permit or deny entry into said network of a plurality of games for participating in game play;
wherein when said applicant-game-contestant is approved for access to said network of a plurality of games, said applicant-game-contestant is granted access to a plurality of electronic games;
a mobile apparatus communicably connected to said game network, said mobile apparatus comprising a mobile computing device including one or more mobile device data processors, and one or more mobile apparatus data storage devices;
said mobile apparatus receiving real-world mapping data, including data corresponding to real-world locations, accessed and processed by said one or more data processors;
said mobile apparatus receiving virtual-world mapping data, including data corresponding to virtual-world locations, accessed and processed by said one or more data processors;
said one or more data processors combining, at least periodically, at least a portion of said virtual world mapping data and at least a portion of said real-world mapping data to synthesize a hybridized real/virtual-world data stream;
said one or more data processors processing said real/virtual-world data stream to generate visual-display-data, said visual-display-data being processed by said one or more data processors to generate a visual display on a user viewable display, said visual display comprising a user-viewable-view of a real-world scene which is periodically or continuously overlayed with a virtual world scene;
said mobile computing device containing a location detecting mechanism which at least periodically detects a real world location of said mobile computing device, and wherein laws applicable to said detected real world location of said mobile computing device are determined according to said detected real world location and thereafter applied by said game network access granting hub to control which games are accessible by said mobile computing device at specific detected locations and/or to tailor rules of game play; and
wherein if said mobile computing device is detected, by said location detecting mechanism, to be located at a specified game-location-target, a game is made accessible while said mobile computing device remains at said game-location-target.

2. The game network according to claim 1 wherein said plurality of electronic games are provided by a plurality of third party providers located in a plurality of states of the United States.

3. The game network according to claim 2 wherein a game of said plurality of electronic games is made accessible while said mobile computing device remains at said game-location-target, only if said game is determined to be legal in the geographic location detected by said location detecting mechanism, after said game network autonomously and automatically determines whether said game, lottery, or sweepstakes is compliant with laws of the detected geographic location by parsing a database pertaining to such laws.

4. An apparatus comprising a mobile computing device including at least one data processor, and at least one data storage device;
said mobile apparatus receiving real-world mapping data, including data corresponding to real-world locations, accessed and processed by said one or more data processors;
said mobile apparatus receiving virtual-world mapping data, including data corresponding to virtual-world locations, accessed and processed by said one or more data processors;
said one or more data processors overlaying at least a portion of said virtual world mapping data onto at least a portion of said real-world mapping data to synthesize a hybridized real/virtual-world data stream;
said one or more data processors processing said real/virtual-world data stream to generate visual-display-data, said visual-display-data being processed by said one or more data processors to generate a visual display on a user viewable display apparatus, said visual display comprising a user-viewable-view of a real-world scene which is periodically or continuously overlayed with a virtual world scene;
said mobile computing device containing a location detecting mechanism which at least periodically detects a real world location of said mobile computing device, and when said mobile computing device is detected, by said location detecting mechanism, to be located at a specified game-location-target, a game is made accessible to a user of said mobile computing device while said mobile computing device remains at said game-location-target; and
and wherein laws applicable to said detected real world location of said mobile computing device are determined according to said detected real world location and thereafter applied to determine and select which games are accessible by said mobile computing device at specific detected locations.

5. The apparatus according to claim 4 wherein a game of said plurality of electronic games is made accessible while said mobile computing device remains at said game-location-target, only if said game is determined to be legal in the geographic location detected by said location detecting mechanism, after said game network autonomously and automatically determines whether said game, lottery, or sweepstakes is compliant with laws of the detected geographic location by parsing a database pertaining to such laws.

6. An apparatus comprising a mobile computing device including at least one data processor, and at least one data storage device;
said mobile computing device receiving real-world mapping data, including data corresponding to real-world locations, accessed and processed by said one or more data processors;
said mobile computing device receiving virtual-world mapping data, including data corresponding to virtual-world locations, accessed and processed by said one or more data processors;
said one or more data processors overlaying at least a portion of said virtual world mapping data onto at least a portion of said real-world mapping data to synthesize a hybridized real/virtual-world data stream;
said one or more data processors processing said real/virtual-world data stream to generate visual-display-data, said visual-display-data being processed by said one or more data processors to generate a visual display on a user viewable display apparatus, said visual display comprising a user-viewable-view of a real-world scene which is periodically or continuously overlayed with a virtual world scene;
said mobile computing device containing a location detecting mechanism which at least periodically detects a real world location of said mobile computing device, and when said mobile computing device is detected, by said location detecting mechanism, to be located at a specified game-location-target, a game is made accessible to a user of said mobile computing device while said mobile computing device remains at said game-location-target; and
wherein said real-world scene is generated live utilizing a camera onboard said mobile computing device, and wherein said virtual world is generated from virtual world data supplied to said mobile computing device; and
wherein said game is rendered from virtual world data, and said game is visible in said user-viewable-view of a real-world scene.

7. The apparatus according to claim 6 further wherein laws applicable to said detected real world location of said mobile computing device are determined according to said detected real world location and thereafter applied to determine and select which games are accessible by said mobile computing device at specific detected locations;

8. The apparatus according to claim 6 further being communicably connected to a game network comprising data transmission equipment, at least one game network data processor, and at least one game network data storage device;
said game network including hardware and/or software particularly configured to control said game network such that it operates to provide a game network access granting hub on which the following method steps are performed:
an applicant-game-contestant electronically submitting applicant access credentials comprising identifying information to said game network access granting hub, accompanied by a request for access to a network of a plurality of games which are selectively accessible to applicant-game-contestants which have been approved for access to said game network access granting hub;
said game network access granting hub receiving said applicant access credentials, processing said applicant access credentials, performing steps to verify a true identity of said applicant-game-contestant, and screening said applicant-game-contestant for criteria to permit or deny entry into said network of a plurality of games for participating in game play;
wherein when said applicant-game-contestant is approved for access to said network of a plurality of games, said applicant-game-contestant is offered game play when said mobile computing device is detected to be located a specified game-location-target.

9. The apparatus according to claim 8 wherein said plurality of games are electronically provided by a plurality of third party providers located in a plurality of states of the United States.

10. The apparatus according to claim 9 wherein a game of said plurality of games is made accessible while said mobile computing device remains at said game-location-target, only if said game is determined to be legal in the geographic location detected by said location detecting mechanism, after said game network autonomously and automatically determines whether said game, lottery, or sweepstakes is compliant with laws of the detected geographic location by parsing a database pertaining to such laws.

11. An apparatus comprising a mobile computing device including at least one data processor, and at least one data storage device;
said apparatus receiving real-world mapping data, including data corresponding to real-world locations, accessed and processed by said one or more data processors;
said apparatus receiving virtual-world mapping data, including data corresponding to virtual-world locations, accessed and processed by said one or more data processors;
said one or more data processors overlaying at least a portion of said virtual-world mapping data onto at least a portion of said real-world mapping data to synthesize a hybridized real/virtual-world data stream;
said one or more data processors processing said real/virtual-world data stream to generate visual-display-data, said visual-display-data being processed by said one or more data processors to generate a visual display on a user viewable display, said visual display comprising a user-viewable-view of a real-world scene which is periodically or continuously overlayed with a virtual world scene;
said mobile computing device containing a travel detecting mechanism which detects when said mobile computing device is physically travelling and which determines a distance of physical travel of said mobile computing device, and wherein when said mobile computing device is determined to have travelled in excess of a selected-target-travel-distance, a game is made accessible to a user of said mobile computing device;
said mobile computing device further containing a location detecting mechanism which at least periodically detects a real world location of said mobile computing device;
wherein laws applicable to said detected real world location of said mobile computing device are determined according to said detected real world location and thereafter applied to determine and select which games are accessible by said mobile computing device at a specific detected location.

12. The apparatus according to claim 11 wherein said travel detecting mechanism of said mobile computing device is so designed as to be capable of determining whether physical travel is by human locomotion versus machine assisted locomotion.

13. The apparatus according to claim 12 further wherein only physical travel which occurs by human locomotion, to the exclusion of machine assisted locomotion, is tallied when determining whether a distance of physical travel of said mobile computing device is in excess of said selected-target-travel-distance.

14. The apparatus according to claim 12 wherein mobile computing device travel distances are tallied by said mobile computing device as detected by said travel detecting mechanism, and when travel is detected to occur by human locomotion only, a game is made accessible to a user of said mobile computing device when said mobile computing device has travelled in excess of a selected-target-travel-distance; and
when travel is detected to occur by machine assisted locomotion, a game is made accessible to a user of said mobile computing device when said mobile computing device has travelled in excess of a target-machine-locomotion-travel-distance, which is a distance greater than said selected-target-travel-distance.

15. A device for motivating physical human-powered movement of a human user comprising the apparatus according to claim 12, wherein if no human locomotion is detected, no game is made accessible to a user of said mobile computing device.

16. The device for motivating physical human-powered movement of a human user according to claim 12 wherein if only machine assisted locomotion is detected, a message is displayed in said user-viewable-view notifying a user of said mobile computing device that games will not be made accessible to said user during said machine assisted locomotion.

17. The apparatus according to claim 12 wherein if only machine assisted locomotion is detected, use of said mobile computing device is suspended.

18. The apparatus according to claim 12 wherein if machine assisted locomotion is detected, game play is suspended.

19. The apparatus according to claim 6 further including a database of a plurality of game-location-targets which is accessed by said mobile computing device, said game-location targets being selected by a plurality of third party entities.

20. The apparatus according to claim 19 wherein said plurality of third party entities self-upload said plurality of game-location-targets into said database containing said plurality of game-location-targets.

21. The apparatus according to claim 20 wherein said plurality of third party entities self-upload said plurality of game-location-targets into said database containing said plurality of game-location-targets, and wherein said plurality of third party entities supply target-affiliated electronic game data, for generating a game in said user-viewable-view, when said mobile computing device is detected to be at a geographic location corresponding to one of said plurality of game-location-targets supplied by one of said plurality of third party entities.

22. The apparatus according to claim 21 wherein said target-affiliated electronic game data is tailored to specific game-location-targets, such that different game-location-targets are affiliated with different target-affiliated electronic game data, and wherein said different target-affiliated electronic game data, when processed by said mobile computing device, generates different games playable on said mobile computing device.

23. The apparatus according to claim 19 wherein said plurality of third party entities supply target-affiliated electronic game data, for generating a game in said user-viewable-view, when said mobile computing device is detected to be at a geographic location corresponding to one of said plurality of game-location-targets supplied by one of said plurality of third party entities and said target-affiliated electronic game data is tailored to specific game-location-targets, such that different game-location-targets are affiliated with different target-affiliated electronic game data, and wherein said different target-affiliated electronic game data, when processed by said mobile computing device, generates different games playable on said mobile computing device.

24. The apparatus according to claim 23 wherein said plurality of third party entities collectively supply a plurality of said target-affiliated electronic game data corresponding to a plurality of different games playable on said mobile computing device, and wherein said plurality of third party entities are located in a plurality of states of the United States.

25. The apparatus according to claim 24 wherein a game of said plurality of different games is made accessible while said mobile computing device remains at a said game-location-target, only if said game is determined to be legal in the geographic location detected by said location detecting mechanism, after said game network autonomously and automatically determines whether said game, lottery, or sweepstakes is compliant with laws of the detected geographic location by parsing a database pertaining to such laws.

26. The apparatus according to claim 8 wherein said applicant access credentials comprise the face of said applicant-game-contestant, which is detectable using facial recognition technology and is compared to a facial image of said applicant-game-contestant stored in a screening database associated with said game network access granting hub.

27. The apparatus according to claim 26, wherein said facial recognition technology utilizes a camera in, or otherwise connected to or associated with said mobile computing device of said applicant-game-contestant.

28. The apparatus according to claim 27, wherein said camera monitors a face of a user of said mobile computing device by periodically or continuously comparing said user's face to a facial image of said applicant-game-contestant stored in said screening database.

29. The apparatus according to claim 28, wherein said facial recognition technology prevents children, other family members, or another unauthorized user from accessing a player profile of said applicant-game-contestant.

30. The apparatus according to claim 29, wherein if said facial recognition technology detects unauthorized use of said player profile, said facial recognition technology takes a photograph or video of said unauthorized user, followed by transmitting said photograph or video to said applicant-game-contestant to identify said unauthorized user.

31. The apparatus according to claim 27, wherein said applicant access credentials further comprise an internet protocol (IP) address, MAC address, or other identifier of said laptop, other computer, or mobile device of said applicant-game-contestant, so that if an IP address, MAC address, or other identifier of a user does not match said applicant-game-contestant's IP address, MAC address, or other identifier stored in said screening database associated with said game network access granting hub, said game network access granting hub can utilize said facial recognition technology to compare said user's face to said facial image of said applicant-game-contestant stored in said screening database associated with said game network access granting hub.

32. The apparatus according to claim 27 further including software generated virtual characters which appear in said user-viewable-view during a said game, and wherein an image of said face of said applicant-game-contestant, which is captured utilizing said camera utilized with said facial recognition technology, is integrated into said game as a visual representation of a game character.

33. The apparatus according to claim 6 wherein said user-viewable-view is supplemented with imagery stored in a database which is representative of said real world location detected by said location detecting mechanism.
